(19) United States
(12) Patent Application Publication
(10) Pub. No.: US 2014/0094241 A1
(43) Pub. Date: Apr. 3, 2014

(54) WAGERING GAME WITH PROGRESSIVE JACKPOT AWARD DRIVEN BY SOCIAL COMMUNICATIONS

(71) Applicant: WMS GAMING INC., Waukegan, IL (US)

(72) Inventors: Andrew C. Guinn, Chicago, IL (US); Daniel P. Louie, Chicago, IL (US); Travis N. Nelson, Canton, GA (US); Richard B. Robbins, Glenview, IL (US); Eric T. Ryan, Crest Hill, IL (US); Rory M. Shanahan, Chicago, IL (US)

(73) Assignee: WMS GAMING INC., Waukegan, IL (US)

(21) Appl. No.: 13/793,237

(22) Filed: Mar. 11, 2013

Related U.S. Application Data
(60) Provisional application No. 61/707,372, filed on Sep. 28, 2012.

(51) Int. Cl. G07F 17/32

(52) U.S. Cl. CPC G07F 17/3255
USPC 463/16; 463/27

(57) ABSTRACT

Systems and methods include one or more processing devices configured to provide or send displayable content over a network to a client. The displayable content provides a wagering game system. The wagering game system includes a progressive wagering game that awards one or more progressive jackpot awards to a player. In response to social communications by the player over the network, the wagering game system provides a reward to the player, where the reward relates to the progressive wagering game or the one or more progressive jackpot awards.

### CROSS-REFERENCE TO RELATED APPLICATION

This application claims the benefit of U.S. Provisional Application No. 61/707,372, filed Sep. 28, 2012, which is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to gaming apparatus and methods that provide a progressive jackpot award in response to activity relating to electronic social communications.

### BACKGROUND OF THE INVENTION

Gaming terminals, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to aspects of the present invention, gaming apparatus and methods provide rewards relating to progressive jackpot awards in response to activity relating to electronic social communications.

According to some embodiments, systems and methods include one or more processing devices configured to provide or send displayable content over a network to a client. The displayable content provides a wagering game system. The wagering game system includes a progressive wagering game that awards one or more progressive jackpot awards to a player. In response to social communications by the player over the network, the wagering game system provides a reward to the player, where the reward relates to the progressive wagering game or the one or more progressive jackpot awards.

The reward may affect a probability of winning the one or more progressive jackpot awards. The reward may modify a value of the one or more progressive jackpot awards. The reward may determine an eligibility of the player to play the progressive wagering game. The reward may modify an aspect of the progressive wagering game for play by the player. The reward may vary based on a response by other people to the social communications.

The wagering game system may provide a link to a social communications site on the network, the link allowing the player to share social communications over the network. The link to the social communications site on the network may provide a prepared message for the social communications by the player, the prepared message including another link from the site on the network back to the wagering game system.

The wagering game system may provide the reward for each social communication by the player over the network, and the player becomes eligible to win the one or more progressive jackpot awards after receiving a plurality of the rewards.

The wagering game system may include one or more basic wagering games, where an eligibility of the player to play the progressive wagering game may be determined by an occurrence of an outcome in the one or more basic wagering games played by the player, and the reward may increase the probability of the occurrence of the outcome in the one or more basic wagering game.

The wagering game system may include one or more basic wagering games, where the eligibility of the player to play the progressive wagering game may be determined by an occurrence of an outcome in the one or more basic wagering games played by the player, and the reward may provide an amount of time for the player to achieve the occurrence of the outcome in the one or more basic wagering games.

The one or more progressive jackpot awards may include a plurality of levels of progressive jackpot awards of different values, and the reward may determine the level of progressive jackpot award that the player can win in the progressive wagering game.

According to other embodiments, systems and methods include a display device configured to display a progressive wagering game that awards one or more progressive jackpot awards to a player. The systems and methods also include one or more processing devices configured to identify social communications by the player over a network and provide a reward to the player in response to the communications by the player over the network, where the reward relating to the progressive wagering game or the one or more progressive jackpot awards.

According to further embodiments, one or more physical machine-readable storage media include instructions which, when executed by one or more processors, cause the one or more processors to perform operations including: providing a progressive jackpot award at a gaming website on a network; and in response to social communications over the network by a player of games at the gaming website, modifying at least one of a probability of the player winning the progressive jackpot award and an amount of the progressive jackpot award if won by the player.

The operations may further include providing the player with chances of winning the progressive jackpot award as the player plays the games at the gaming website. The modifying may include providing the player with an additional chance of winning the progressive jackpot award.

In response to the social communications over the network by the player, the operations may further include contributing an amount to the progressive jackpot award.

The operations may further include awarding the progressive jackpot award if the contributed amount causes the progressive jackpot award to reach a predetermined threshold.

The operations may further include measuring an effect of the social communications on bringing other players to the gaming website, wherein the modifying varies with the measured effect.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 illustrates an example free-standing gaming terminal according to an embodiment of the present invention.

FIG. 2 illustrates a gaming system according to an embodiment of the present invention.

FIG. 3 illustrates an example reel-based game screen of a wagering game displayed on a gaming terminal, according to an embodiment of the present invention.

FIG. 4 illustrates an example player-selection game screen of a wagering game displayed on a gaming terminal, according to an embodiment of the present invention.

FIG. 5 illustrates another example free-standing gaming-terminal including the reel-based game screen of FIG. 3 and a progressive jackpot award screen, according to an embodiment of the present invention.

FIG. 6 illustrates yet another example free-standing gaming-terminal including the player-selection game screen of FIG. 4 and a progressive jackpot award screen, according to an embodiment of the present invention.

FIG. 7A illustrates an example web site including a game screen and a progressive jackpot award screen, according to an embodiment of the present invention.

FIG. 7B illustrates the example web site of FIG. 7A and a social media posting screen launched from the web site, according to an embodiment of the present invention.

FIG. 7C illustrates example approaches for rewarding a player from the web site of FIG. 7A for particular social media activity, according to an embodiment of the present invention.

FIG. 8 illustrates an example system for identifying network-based communications and providing rewards relating to progressive jackpot awards, according to an embodiment of the present invention.

FIG. 9 illustrates an example forum page that includes posted messages that generate interest in marketable aspects of the wagering game industry, according to an embodiment of the present invention.

FIG. 10 illustrates an example approach for granting rewards relating to progressive jackpot awards in response to a player's network-based communications, according to an embodiment of the present invention.

FIG. 11 illustrates an example weblog page that includes posted messages that generate interest in marketable aspects of the wagering game industry, according to an embodiment of the present invention.

FIG. 12 illustrates an example microblog page that includes posted messages that generate interest in marketable aspects of the wagering game industry, according to an embodiment of the present invention.

FIG. 13 illustrates an example social networking page that includes posted messages that generate interest in marketable aspects of the wagering game industry, according to an embodiment of the present invention.

FIG. 14A-C illustrate example screens on a location-based social networking mobile application that includes posted messages that generate interest in marketable aspects of the wagering game industry, according to an embodiment of the present invention.

FIG. 15 illustrates an example multimedia posting page that includes posted multimedia that generates interest in marketable aspects of the wagering game industry, according to an embodiment of the present invention.

FIG. 16 illustrates an example search engine page that provides search results for postings that generate interest in marketable aspects of the wagering game industry, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games. In some cases, the use of virtual currency issued by a gaming establishment, wagering game manufacturer, etc., may foster loyalty to that gaming establishment, wagering game manufacturer, etc., because the virtual currency is non-fungible and limited to uses associated with the particular institutions. In further embodiments, the wagering game may involve the awarding of non-cash awards, coupons, etc. In yet further embodiments, the wagering game may involve a mixture of real, virtual money, and/or non-cash awards.

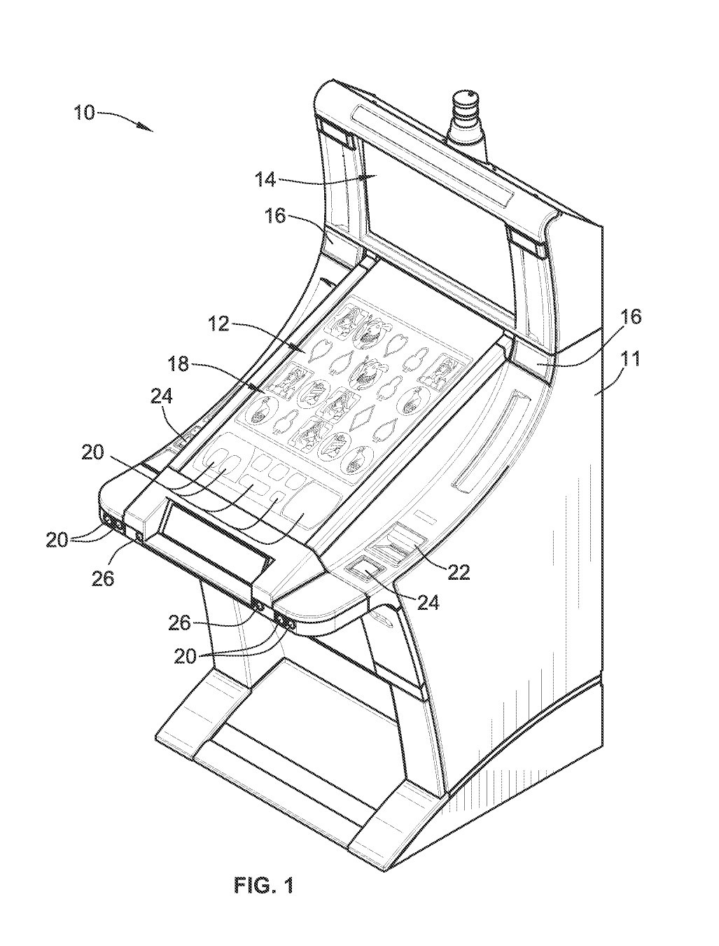

Referring to FIG. 1, there is shown a gaming terminal 10 similar to those used in gaming establishments, such as casinos. With regard to the present invention, the gaming terminal 10 may be any type of gaming terminal and may have varying structures and methods of operation. For example, in some aspects, the gaming terminal 10 is an electromechanical gaming terminal configured to play mechanical slots, whereas in other aspects, the gaming terminal is an electronic gaming terminal configured to play a video casino game, such as slots, keno, poker, blackjack, roulette, craps, etc. The gaming terminal 10 may take any suitable form, such as floor-standing models as shown, handheld mobile units, bartop models, workstation-type console models, etc. Further, the gaming terminal 10 may be primarily dedicated for use in conducting wagering games, or may include non-dedicated devices, such as mobile phones, personal digital assistants, personal computers, etc. Exemplary types of gaming terminals are disclosed in U.S. Pat. No. 6,517,433 and Patent Application Publication Nos. US2010/0069160 and US2010/0234099, which are incorporated herein by reference in their entireties.

The gaming terminal 10 illustrated in FIG. 1 comprises a cabinet 11 that may house various input devices, output devices, and input/output devices. By way of example, the gaming terminal 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming terminal 10. The gaming terminal 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming terminal in accord with the present concepts.

Input devices, such as the touch screen 18, buttons 20, a mouse, a joystick, a gesture-sensing device, a voice-recognition device, and a virtual input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a CPU for processing. The electronic data signals are selected from a group consisting essentially of an electrical current, an electrical voltage, an electrical charge, an optical signal, an optical element, a magnetic signal, and a magnetic element.

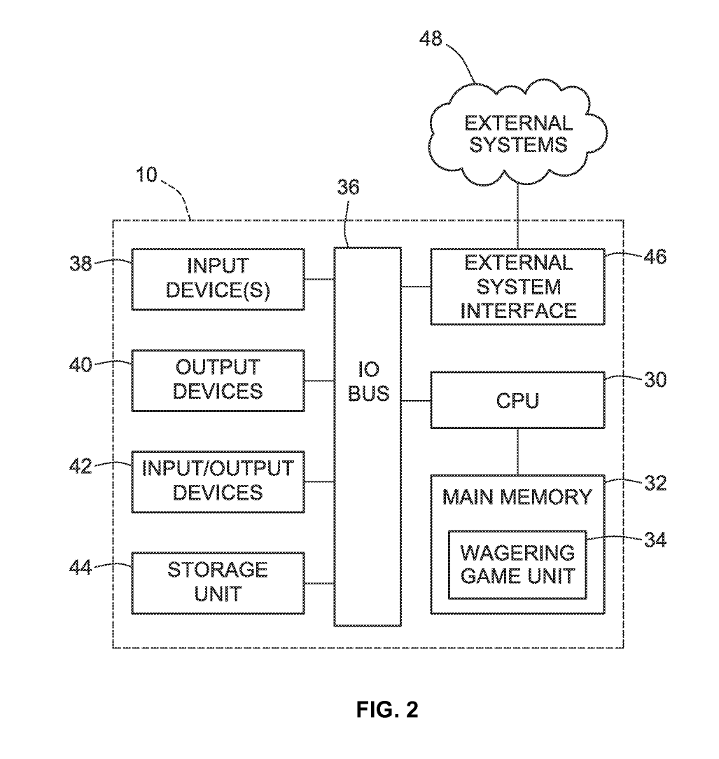

Turning now to FIG. 2, there is shown a block diagram of the gaming-terminal architecture. The gaming terminal 10 includes a central processing unit (CPU) 30 connected to a main memory 32. The CPU 30 may include any suitable processor(s), such as those made by Intel and AMD. By way of example, the CPU 30 includes a plurality of microprocessors including a master processor, a slave processor, and a secondary or parallel processor. CPU 30, as used herein, comprises any combination of hardware, software, or firmware disposed in or outside of the gaming terminal 10 that is configured to communicate with or control the transfer of data between the gaming terminal 10 and a bus, another computer, processor, device, service, or network. The CPU 30 comprises one or more controllers or processors and such one or more controllers or processors need not be disposed proximal to one another and may be located in different devices or in different locations. The CPU 30 is operable to execute all of the various gaming methods and other processes disclosed herein. The main memory 32 includes a wagering game unit 34. In one embodiment, the wagering game unit 34 may present wagering games, such as video poker, video black jack, video slots, video lottery, etc., in whole or part.

The CPU 30 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to storage unit 44 and external system interface 46, which is connected to external system(s) 48 (e.g., wagering game networks).

The external system 48 includes, in various aspects, a gaming network, other gaming terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external system interface 46 is configured to facilitate wireless communication and data transfer between the portable electronic device and the CPU 30, such as by a near-field communication path operating via magnetic-field induction or a frequency-hopping spread spectrum RF signals (e.g., Bluetooth, etc.).

The gaming terminal 10 optionally communicates with the external system 48 such that the terminal operates as a thin, thick, or intermediate client. In general, a wagering game includes an RNG for generating a random number, game logic for determining the outcome based on the randomly generated number, and game assets (e.g., art, sound, etc.) for presenting the determined outcome to a player in an audio-visual manner. The RNG, game logic, and game assets are contained within the gaming terminal 10 (“thick client” gaming terminal), the external system 48 (“thin client” gaming terminal), or are distributed therebetween in any suitable manner (“intermediate client” gaming terminal).

The gaming terminal 10 may include additional peripheral devices or more than one of each component shown in FIG. 2. Any component of the gaming terminal architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic disk storage media, optical storage media, flash memory, etc.

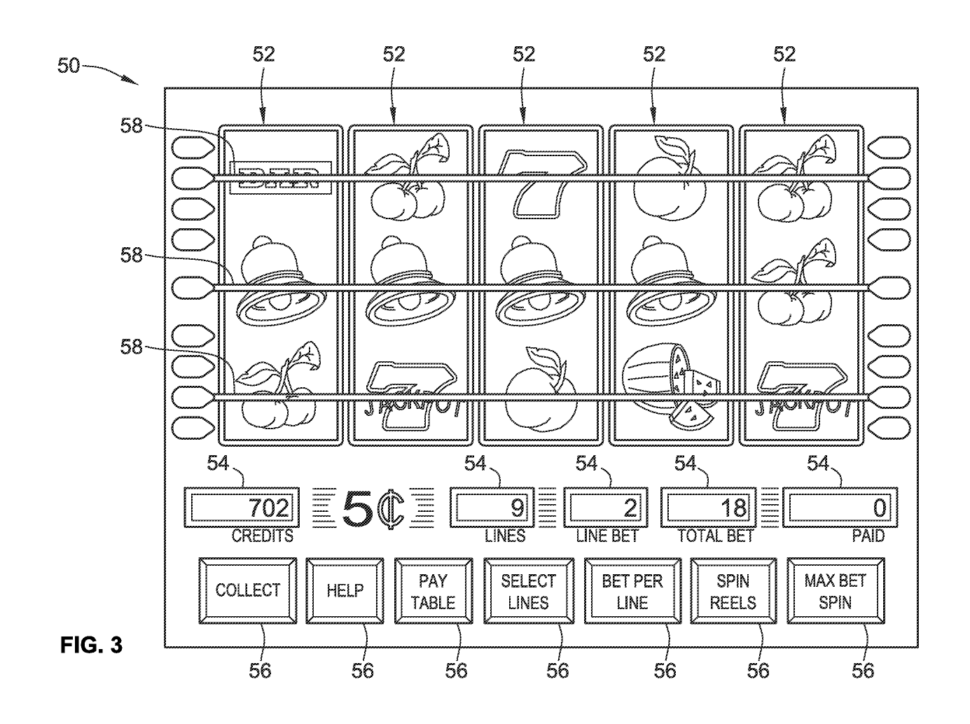

Referring now to FIG. 3, there is illustrated an image of a game screen 50, which may be displayed, for example, on the primary display area 12 or the secondary display area 14 to present the result of a reel-based wagering game. The reel-based game screen 50 portrays a plurality of simulated symbol-bearing reels 52. Alternatively or additionally, the game screen 50 portrays a plurality of mechanical reels or other video or mechanical presentation consistent with the game format and theme. The game screen 50 also displays one or more game-session credit meters 54 and various touch screen buttons 56 adapted to be actuated by a player. A player can operate or interact with the wagering game using these touch screen buttons or other input devices such as the buttons 20 shown in FIG. 1. The CPU operate(s) to execute a wagering game program causing the primary display area 12 or the secondary display area 14 to display the wagering game.

In response to receiving a wager, the reels 52, as shown on the game screen 50, are rotated and stopped to place symbols on the reels in visual association, for example, with paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering game outcome is provided or displayed in response to the wager being received or detected. The wagering game outcome is then revealed to the player in due course following initiation of the wagering game. The method comprises the acts of conducting the wagering game using a gaming apparatus, such as the gaming terminal 10 depicted in FIG. 1, following receipt of an input from the player to initiate the wagering game. The gaming terminal 10 then communicates the wagering game outcome to the player via one or more output devices (e.g., primary display 12 or secondary display 14) through the display of information such as, but not limited to, text, graphics, static images, moving images, etc., or any combination thereof. In accord with the method of conducting the wagering game, the CPU transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the CPU (e.g., CPU 30) is configured to process the electronic data signal, to interpret the data signal (e.g., data signals corresponding to a wager input), and to cause further actions associated with the interpretation of the signal in accord with computer instructions relating to such further actions executed by the controller. As one example, the CPU causes the recording of a digital representation of the wager in one or more storage media (e.g., storage unit 44), the CPU, in accord with associated computer instructions, causing the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU (e.g., the wager in the present example). As another example, the CPU further, in accord with the execution of the instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of computer instructions relating to the wagering game is further conducted in accord with a random outcome (e.g., determined by a RNG) that is used by the CPU to determine the outcome of the game sequence, using a game logic for determining the outcome based on the randomly generated number. In at least some aspects, the CPU is configured to determine an outcome of the game sequence at least partially in response to the random parameter.

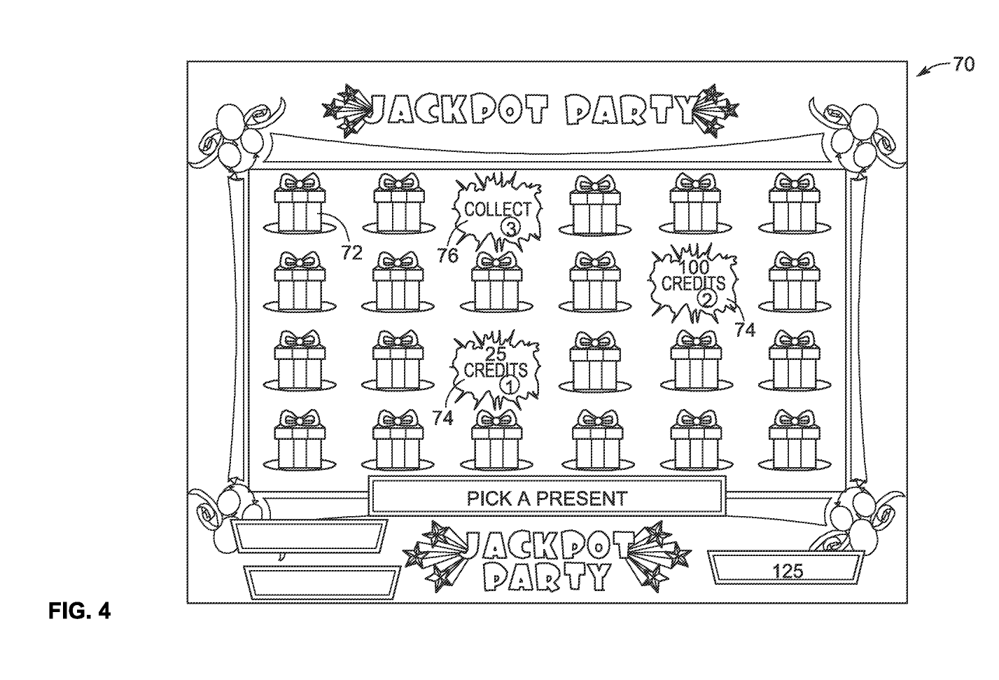

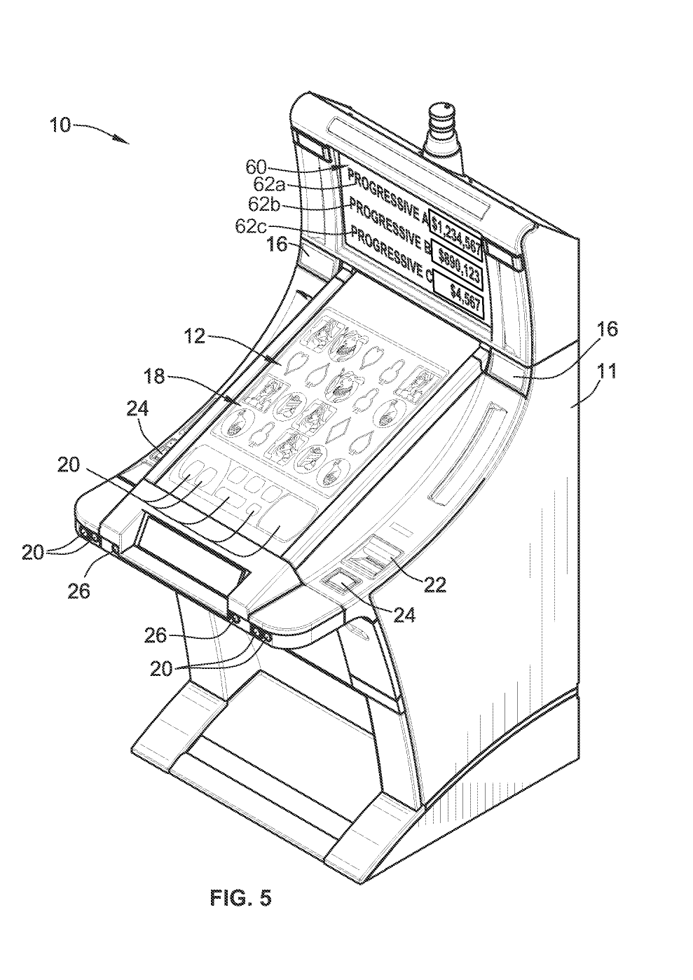

Referring to FIG. 4, an alternative game screen 70 is illustrated. The game screen 70 may be displayed, for example, on the primary display area 12 or the secondary display area 14 to present the result of a wagering game employing player-selectable markers, also known as a “picking game.” In particular, the player-selection game screen 70 includes an array of markers 72 located in a plurality of columns and rows. A player selects, one at a time, from the array of markers 72 to reveal an associated game outcome. According to one embodiment of this game, each marker 72 in the array is associated with an award outcome 74 (e.g., credits or other non-negative outcomes) or an end-game outcome 76. In the illustrated example, a player has selected an award outcome 74 with the player's first two selections (25 credits and 100 credits, respectively). When one or more end-game outcome 76 is selected (as illustrated by the player's third pick), the bonus game is terminated and the accumulated award outcomes 74 are provided to the player.

The reel-based game screen 50 of FIG. 3 or the player-selection game screen 70 of FIG. 4 may be employed in a basic game. Alternatively, the reel-based game screen 50 or the player-selection game screen 70 may be employed in a bonus game. A player must first gain eligibility to play the bonus game. In one example, a basic game is a reel-based wagering game as shown in FIG. 3 and the corresponding bonus game is a player-selection game as shown in FIG. 4. The player gains eligibility to play the bonus game upon the occurrence of a triggering event, such as the occurrence of a start-bonus game outcome (e.g., symbol trigger, mystery trigger, time-based trigger, etc.) in or during the basic wagering game.

FIG. 5 illustrates an image of a progressive jackpot screen 60 that may be displayed, for example, on the secondary display area 14 in combination with the reel-based screen 50 displayed on the primary display area 12. In the gaming industry, a “progressive” game typically involves collecting coin-in data from one or more participating wagering game terminals, contributing a percentage of that coin-in data to a progressive jackpot amount, and awarding that progressive jackpot amount to a player upon the occurrence of a certain progressive-win event. The initial progressive jackpot may be a predetermined minimum amount. That jackpot amount, however, progressively increases as players continue to play the gaming machine without winning the jackpot. Further, when several gaming machines are linked together such that several players at several gaming machines compete for the same jackpot, the jackpot progressively increases at a much faster rate, which leads to further player excitement. By providing players with other opportunities to win awards, progressive games enhance player entertainment. In addition, the size of the progressive jackpot awards, which may be larger than other awards for the basic game, increases player interest in the wagering game. Furthermore, progressive jackpot awards provide players with additional incentive to play a wagering game repeatedly. As shown in FIG. 4, the progressive jackpot screen 60 displays three different jackpot meters 62a-c associated respectively with three different progressive jackpots, which grow to different values according to different contributions from the participating wagering game terminals. Each of the different progressive jackpots is associated with different progressive-win events.

A progressive-win event may occur in any number of ways. For example, as shown in FIG. 5, the reel-based game screen 50 may be employed in a basic game, and a progressive-win event occurs when specific reel symbols and/or reel symbol combinations appear after a spin in the game screen 50. The progressive-win events corresponding to the different jackpot meters 62a-c require the appearance of different respective reel symbols and/or reel symbol combinations.

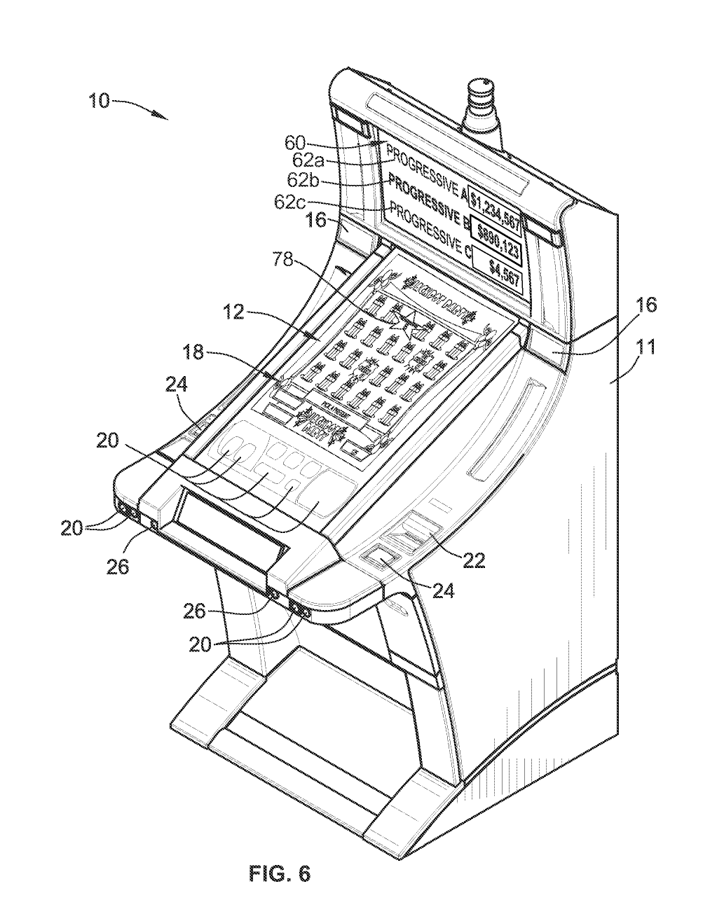

Alternatively, as shown in FIG. 6, the player-selection game screen 70 may be shown on the primary display area 12 in combination with the progressive jackpot screen 60 shown on the secondary display area 14. In one embodiment, the player-selection game screen 70 is employed in a progressive game, and a progressive-win event occurs when specific player-selectable markers 78 appear on the game screen 70. The progressive game may be a bonus game, where the player must first gain eligibility to play for one of the progressive jackpot awards shown in meters 62a-c. As described above, a player may become eligible to play the progressive game when a triggering event occurs in a basic game, e.g., the appearance of specific reel symbols in a reel-based basic game.

While progressive-win events may occur with an outcome that is visually displayed on a wagering game screen, e.g., the reel-based game screen 50 and the player-selection game screen 70, other embodiments may award progressive jackpot awards without prior visual indication of a progressive-win event, i.e., a “mystery” progressive game. In one “mystery” progressive game, the participating wagering game terminals contribute to an incrementally increasing progressive jackpot award. A random threshold value is determined for the progressive jackpot award. When a contribution from a wagering game terminal causes the progressive jackpot award to reach the random threshold value, the player at the wagering game terminal wins the progressive jackpot award. Although players can see the value of the progressive jackpot award, the progressive-win event is a “mystery” because the random threshold value remains unknown and the players do not know when the progressive jackpot award will reach the random threshold value. The threshold changes to a new random value when a player wins the progressive jackpot award and the progressive jackpot award must be restarted.

In another “mystery” progressive game, the participating wagering game terminals contribute to an incrementally increasing progressive jackpot award. Each time a player plays a wagering game at one of the participating wagering game terminals, a random number is drawn. If the drawn number falls within a predefined range of random numbers, the player is awarded the progressive jackpot award. The progressive-win event is a “mystery” because the random number drawn and the determination of whether that drawn number is in the predefined range remain unknown. In some cases, the range is greater if wager for the wagering game is greater. A greater range increases the chances that the random number drawn will fall within the range. In other cases, a random number is drawn for each credit wagered on the wagering game. The number of drawings depends on the wager for the wagering game, so a greater wager results in more drawings and a greater chance that a drawn number will fall within the range. For example, a wager of ten credits may result in ten drawings, while a wager of one credit may result in a single drawing.

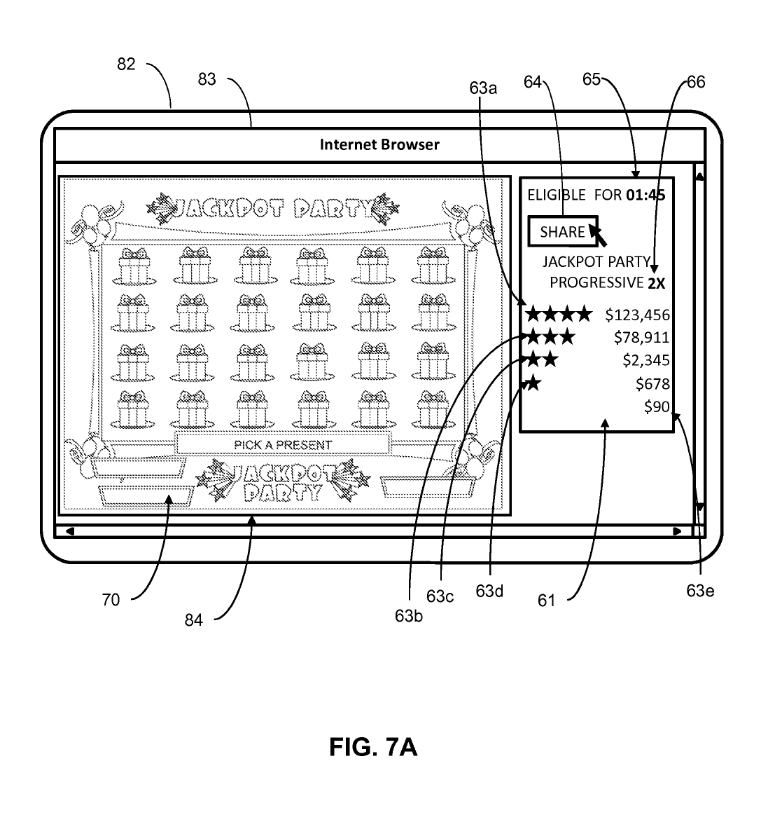

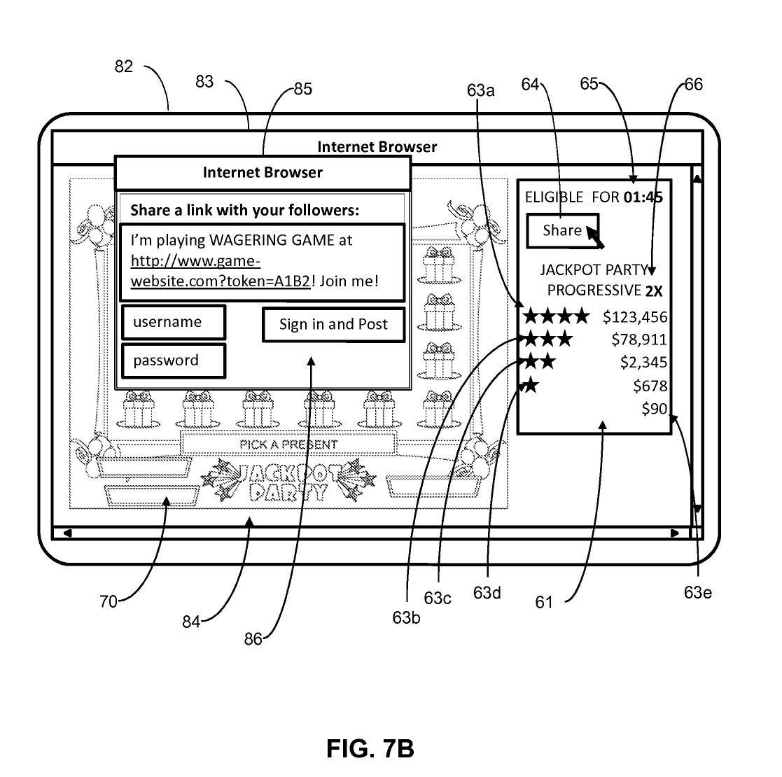

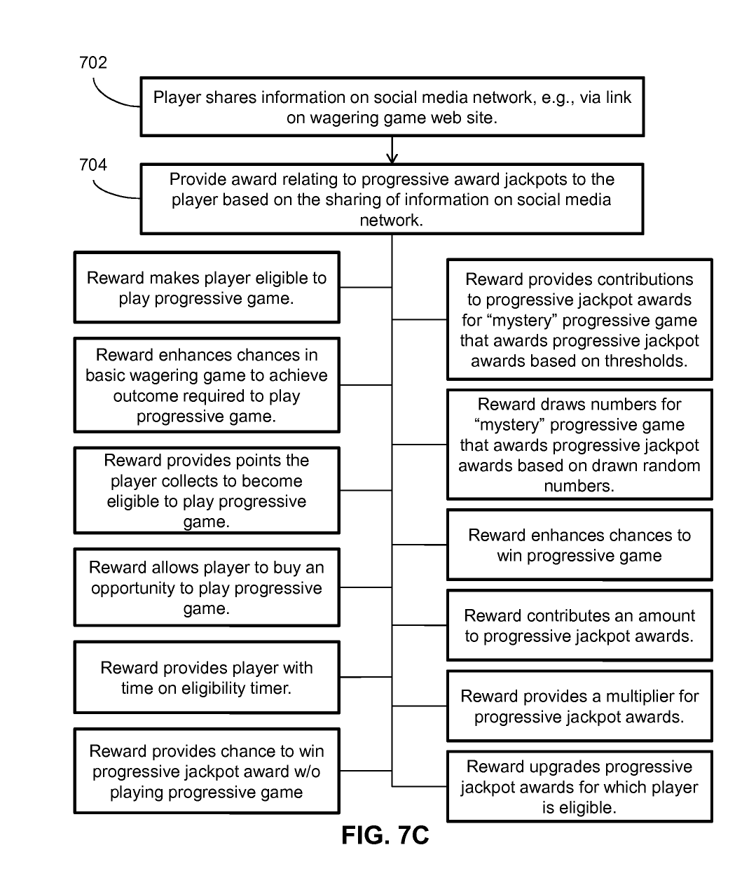

As FIGS. 5 and 6 illustrate, the reel-based game screen 50 and the player-selection game screen 70 may be displayed on the display areas of a device primarily dedicated for use in conducting wagering games, e.g., the gaming terminal 10. In other embodiments, the game screens 50, 70 are displayed on non-dedicated devices, such as mobile phones, personal digital assistants, personal computers, etc. These non-dedicated devices may operate on a computer network, such as the World Wide Web available on the Internet. Indeed, as described above, wagering games may be conducted on web sites. For example, FIG. 7A illustrates an Internet browser 83 on a computer monitor 82 displaying a web site 84 for a wagering game. In particular, the web site 84 includes the player-selection game screen 70 and a progressive jackpot award screen 61. As the player plays different basic games on the web site 84, the progressive jackpot ward screen 61 is displayed to encourage the player to continue playing for a chance to play for the progressive jackpot awards shown in meters 63a-e. In the example of FIG. 7A, the player-selection game screen 70 may be a progressive game, and the player plays the progressive game to win any of the progressive jackpot awards by selecting the appropriate player-selectable marker(s). The player may gain eligibility to play the progressive game by achieving a particular outcome in a basic game displayed in a prior screen.

According to current trends, widespread interest in a subject can be generated quickly through communications on social media. An individual shares information on the subject with other people on a social media network, those other people in turn share the same information to yet other people on the social media network, and so on. As people continue to pass on the information, the information can spread exponentially and become “viral.” Generating publicity through social media requires the mass participation of individuals, each of whom contribute to communications that collectively drive the dynamics of social media.

In a commercial context, there are efforts to use social media to promote products, commercial establishments, companies, etc. In the wagering game industry, social media can likewise be used to generate interest in wagering games, wagering game web sites, gaming establishments, wagering game manufacturers, and other marketable aspects of the wagering game industry. Such efforts, however, face the challenge of creating incentives that can mobilize individual members of social media networks to share information about topics relating to wagering games.

As described above, the excitement associated with progressive jackpot awards provides a highly effective incentive for players to play wagering games. Aspects of the present invention use the same excitement to encourage individual members of social media networks to share information about wagering games, gaming establishments, wagering game manufacturers, etc. According to aspects of the present invention, individuals receive rewards relating to progressive jackpot awards as an incentive to engage in activity on social media that generates interest these areas.

In addition to displaying the progressive jackpot award meters 63a-e, the progressive jackpot award screen 61 in FIG. 7A also displays a share function 64 (e.g., pushbutton) that the player can select (e.g., click with a mouse) to share information over social media. The share function 64 links the wagering game web site 84 to a social media network or a tool for communicating on a social media network. In some embodiments, one or more pushbuttons for the share function 64 may each be labeled with a respective icon representing a popular social media web site, e.g., an icon for FACEBOOK® or TWITTER®. As shown in FIG. 7B, when the player selects the share function 64, the web site 84 launches a secondary Internet browser 85, which displays a posting screen 86 that allows the player to post information through his/her account on a social media web site. For example, an information field 85a may include a prepared message that the player can conveniently post by providing a username and a password for his/her social media web site account in the corresponding fields 85b, c. The posting screen 86 provides a convenient tool that allows the player to communicate quickly over a social media site without having to access the actual site. It is understood, however, that a share function can initiate social media communication in any manner and the share function may provide a link to any of type of web site, including the example web sites described further below. For example, the web site 84 may create a video recording of the player playing the wagering games on the web site 84 and the share function allows the player to post the video on a multimedia posting web site to generate interest on the (e.g., YOUTUBE®).

When the player selects the share function 64 and posts information, the web site 84 responds by providing the player with some reward that relates to the progressive jackpot awards shown in the progressive jackpot award screen 61. The reward provides incentive for the player to share information relating to the wagering game web site 84. FIG. 7C illustrates example approaches for granting rewards (act 704) relating to progressive jackpot awards in response to a player's social media communications in act 702.

As shown FIG. 7C, some rewards relate to giving the player a chance to win a progressive jackpot award. As described above, the player may gain eligibility to play the progressive game by achieving a particular outcome in other games on the web site 84. As such, the web site 84 provides the player additional chances to win a progressive jackpot award as a reward for communicating via the share function 64 in act 702. In alternative embodiments, some or all progressive jackpot awards may only available to players who engage in social communications via the share function 64.

In some embodiments, when the player communicates via the share function 64 in act 702, the web site 84 gives a player a chance to win a progressive jackpot award by making the player eligible to play the progressive game. In other embodiments, however, the player may win the progressive jackpot award without having to play the progressive game.

In yet other embodiments, when the player communicates via the share function 64, the web site 84 enhances the player's chances to achieve an outcome in a basic game that in turn makes the player eligible to play the progressive game. In other words, the web site 84 modifies the probability, i.e., increases the expected value (EV), for triggering the progressive game from a basic game. Alternatively or additionally, the web site 84 may also modify the probability of winning a progressive jackpot award in the progressive game.

In further embodiments, when the player communicates via the share function 64, the web site 84 allows the player to buy an opportunity to play the progressive game directly. In yet further embodiments, every time the player selects the share function 64, the web site 84 provides the player with an incremental number of reward points that are tracked with an account for the web site 84, and the player becomes eligible to play the progressive game when the number of reward points exceeds a threshold number.

As described previously, the player may be required to achieve a particular outcome in a basic game to gain eligibility to play the progressive game. The web site 84, however, may further restrict a player's ability to gain eligibility to play the progressive game. For example, the progressive jackpot award screen 61 in FIG. 7A displays a timer 65 that indicates that the player has a limited amount of time, e.g., 1 hour, 45 minutes, to achieve a particular outcome in a basic game to gain the eligibility. In other words, after the limited amount of time has elapsed, the player cannot play the progressive game, even if he/she achieves the particular outcome in a basic game. The timer 65 encourages the player to continue playing basic games during the specified time period starting at a specific date/time (e.g., a non-peak time). In general, the player may gain eligibility to play the progressive game by the occurrence of a particular event on the web site 84, but the particular event must occur during the time period indicated by the timer 65. Accordingly, when the player communicates via the share function 64, the web site 84 may provide (additional) time on the timer 65 to give the player time to gain eligibility to play the progressive game.

As described above, some progressive games award a progressive jackpot award to a player when a contribution from the player's wagering game causes the progressive jackpot award to reach a random threshold value. If the web site 84 includes such “mystery” progressive games, the web site 84 may reward the player by making one or more direct contributions directly to the progressive jackpot award, without requiring the player to play a wagering game. If one of the contributions directly from the web site 84 causes the progressive jackpot award to reach the threshold, the player wins the progressive jackpot award. The contributions, in some cases, may have different or random values. The number of contributions and/or the size of the contributions may depend on the communication made via the share function 64.

As also described above, in other “mystery” progressive games, at least one random number is drawn each time a player plays a wagering game and if the number falls within a predefined range, the player wins the progressive jackpot award. If the web site 84 includes such “mystery” progressive games, the web site 84 may reward the player by drawing one or more random numbers for the player, without requiring the player to play a wagering game. If one of the numbers falls within the predefined range, the player wins the progressive jackpot award. The number of drawings and/or the size of the range may depend on the communication made via the share function 64. The chances of winning a progressive award increases with the number of drawings and/or the size of the range.

Additionally or alternatively, the web site 84 may also modify the progressive jackpot awards that the player can win. For example, in response to the player communicating via the share function 64, the web site 84 may contribute an additional amount to the progressive jackpot awards.

As shown in FIG. 7A, the progressive jackpot award screen 61 includes a multiplier 66, e.g., a “2X” multiplier, which multiplies any progressive jackpot that the player wins by a factor. Accordingly, the web site 84 may provide or increase a multiplier as a reward when the player shares information in social media via the share function 64.

In alternative embodiments, the timer 64 may limit the amount of time that the multiplier 66 remains in effect. Here, the web site 84 may reward the player by providing (additional) time on the timer 65 and improving the player's chance to win a greater progressive jackpot award.

In addition, FIG. 7A shows that there are different levels of progressive jackpot awards, e.g., from zero stars to four stars, corresponding to the meters 63a-e. In some embodiments, the player may be eligible to win up to a certain level of progressive jackpot award. As a reward, the web site 84 may upgrade the levels of the progressive jackpot awards that the player is eligible to win. In other embodiments, the web site 84 may allow the player to opt out of winning a progressive jackpot award at one level and to continue playing for a progressive jackpot award at a higher level.

As described above, the information field 85a in the posting screen 86 shown in FIG. 7B includes a prepared message that the player can conveniently share. As FIG. 7B shows, the prepared message provides a web address (URL) for the web site 84 and invites others to play wagering games on the web site 84. The URL also includes a unique token (or other unique identifier) that ties the message with the player. Thus, when other people receive the player's social media post and access the web site through the unique URL, the web site 84 can attribute the visits by these other people to the player's social media post. As such, the web site 84 can determine how much interest the player's social media post generates. In response, the web site 84 can enhance the reward it gives to the player based on the number of referrals it gained through the unique URL and/or the amount of gameplay it receives from the referrals. For example, the web site 84 may provide additional opportunities to play the wagering game, increase the multiplier, provide more eligibility time, etc. The greater number of referrals and/or the greater amount of gameplay may result in a greater award, so that the player is encouraged to generate as much interest as possible. Additionally, the web site 84 may provide the player with a “commission” based on the amount of gameplay and/or the awards won by the referrals. In general, aspects of the present invention may employ unique identifiers in social media communications to track referrals and measure the interest generated by the communications and to reward players based on this measured interest.

Because the wagering game web site 84 and social media sites reside on the same network, the web site 84 is electronically and directly, tied via the share function 64, to the player's social media activity. Aspects of the present invention, however, do not require a direct network link between a wagering game system and social media sites. As described further below, embodiments may employ other approaches for monitoring social media activity by players and encouraging players to engage in social media activity. Indeed, the progressive jackpot awards may be available through real gaming terminals, e.g., in a physical gaming establishment, as well as wagering game web sites.

In general, embodiments determine when a player has engaged in desired network-based communications and provide rewards relating to progressive jackpot awards that can be redeemed on a wagering game web site or through gaming terminals in a gaming establishment. Although the examples described herein may involve “social media” sites, it is understood that aspects of the present invention apply to any type of communication of information. In addition, although examples of social media/communications sites are widely available on the World Wide Web, it is understood that aspects of the present invention apply to any public or private computer or telecommunications network through which information can be communicated.

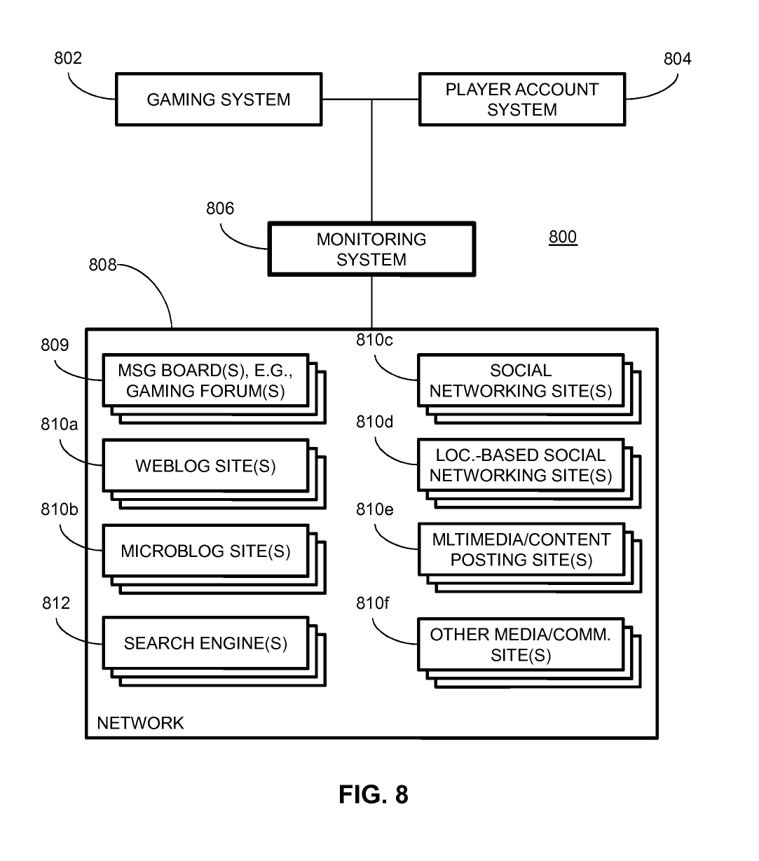

FIG. 8 illustrates an example system 800 for rewarding players who engage in network-based communications and generate interest in wagering games, wagering game web sites, wagering game manufacturers, gaming establishments, and/or other marketable aspects of the wagering game industry. As shown in FIG. 8, the system 800 includes a monitoring system 806 that monitors communications that occur on a network 808, such as the World Wide Web. In particular, the monitoring system 806 may employ a server that is connected to the network 808 and that includes processing hardware, e.g., CPU(s), that executes programmed instructions on computer-readable storage media to monitor particular web sites on the network. As FIG. 8 also illustrates, the monitoring system 806 is coupled to, or otherwise combines with, a gaming system 802, which includes the progressive game(s) that are used to reward players for their communications on the network 808. The gaming system 802 may include a server that includes processing hardware, e.g., CPU(s), that executes programmed instructions on computer-readable storage media to serve content and data for a wagering game web site on a client, such as mobile phones, personal digital assistants, personal computers, etc. Alternatively or additionally, the gaming system 802 may include one or more gaming terminals.

For example, FIG. 8 shows that the monitoring system 806 is connected to one or more message board web site(s) 809 though the network 808. In some embodiments, the message board web site(s) 809 include forums specifically directed to subjects relating to the wagering game industry. For example, such forums allow people to communicate information about wagering games, gaming establishments, wagering game web sites, wagering game manufacturers, and/or other marketable aspects of the wagering game industry. In some embodiments, a wagering game manufacturer may host forums to create an online community to foster interest in its wagering games. The players may discuss aspects of the manufacturer's wagering games with each other. Additionally, the players may interact with designers and other representatives from by the manufacturer. The manufacturer may offer rewards to encourage players to participate in the forums and generate interest among other players. In some embodiments, players may enroll in a player account system 804 to become members of the manufacturer's online community and to gain access to the forums. The player account system 804 includes processing hardware, e.g., CPU(s), and storage media to store and manages the enrollment data. Accordingly, the monitoring system 806 may monitor communications in these forums to identify players who should receive a reward.

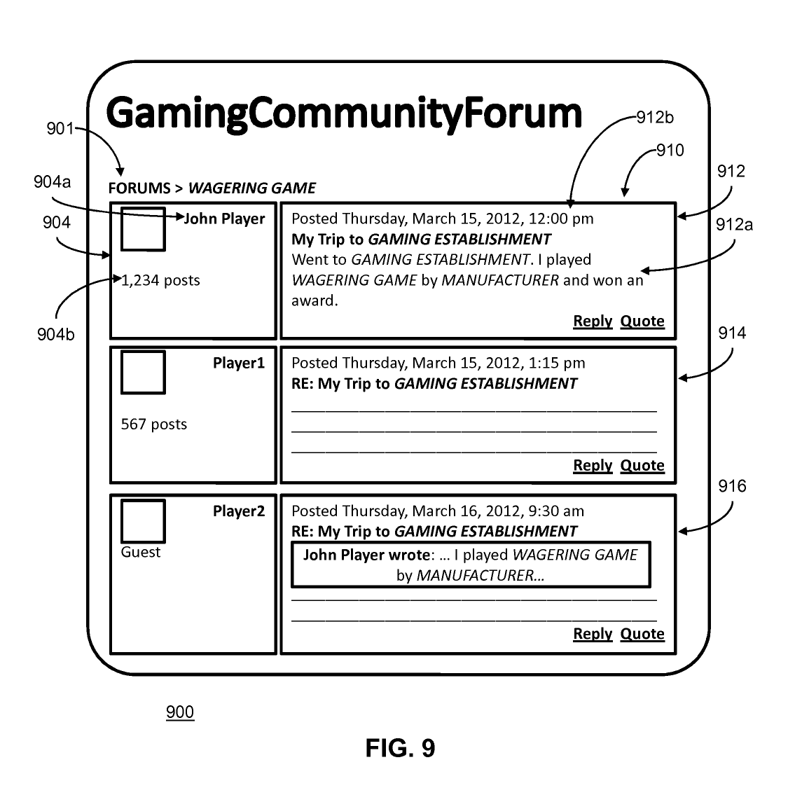

FIG. 9 illustrates an example forum page 900 for an online community dedicated to discussions about a particular wagering game (“WAGERING GAME”). As shown in the heading 901, the forum page 900 is directed to the wagering game, and a series of messages 910 has been posted on this subject. It is contemplated, however, that other forums may be directed to other aspects of the gaming industry. Rewards may be provided for any of the series of messages 910 on the forum page 900.

For example, the series of messages 910 includes a message post 912 under a handle “John Player,” which is associated with a player who is enrolled in the player account system 804. The body 912a of the message post 912 mentions the name of the particular wagering game (“WAGERING GAME”), as well as the name of a gaming establishment (“GAMING ESTABLISHMENT”) and the name of the manufacturer of the wagering game (“MANUFACTURER”). The message post 912 creates interest in the wagering game as well as the gaming establishment and the wagering game manufacturer.

When the monitoring system 806 identifies the message post 912, monitoring system 806 can quickly match the message post 912 with the player in the player account system 804, because the player's access to the forum is tied directly to the account he/she created in the player account system 804. The player receives a reward in response to the posting of the message post 912. In some embodiments, for example, the player becomes immediately eligible to play a progressive game to win a progressive jackpot award. In other embodiments, the player is rewarded with an incremental number of reward points that are tracked with his/her account in the player account system 804, and the player earns an opportunity to play the progressive game when the number of reward points exceeds a threshold number. In further embodiments, the player is allowed to buy a direct opportunity to play the progressive game.

As described above, the rewards may be related to progressive jackpot awards on a wagering game web site and may be redeemed with an electronic (or software) token, which is transmitted electronically to the player. The electronic token applies the reward to the web site. Alternatively or additionally, the rewards may be related to progressive games on real gaming terminals, e.g., in a physical gaming establishment. To redeem the rewards, the player may also receive an electronic or physical token that can be redeemed at the real gaming terminals. In some cases, the player may be required to make a monetary side bet to redeem the token. Alternatively or additionally, the player may receive a printable coupon that may be electronically delivered to the player and printed by the player on a conventional printer. The printed coupon can then be presented at a gaming establishment for redemption. Alternatively or additionally, the reward may be stored with a player's account and redeemed when the player accesses his/her player's account from the web site or from a real gaming terminal. In some embodiments, the reward can be shared with other players. In other embodiments, the same or different rewards can be combined in one session, e.g., one play of a progressive game can include any combination of the rewards described herein.

FIG. 9 shows that the series of messages 910 includes messages 914 and 916 that have been posted in response to the message post 912 posted by “John Player.” The message posts 914 and 916 demonstrate that other people have read the post 912 and have shown enough interest to respond directly to the message post 912. As such, the number of responses to the message post 912 provides a quantitative measure of the amount of interest that the message post 912 has generated. The monitoring system 806 can use the number of responses to determine what reward to provide the player. Again, the reward may be enhanced with a greater number of responses.

Because aspects of the system 800 and the forum page 900 may both be hosted by the same wagering game manufacturer, the monitoring system 806 can have direct access to the forum page 900 and be specially configured to monitor the series of messages 910 on the forum page 900. However, in some embodiments, the message board web site(s) 809 may include public web sites that are not hosted by a wagering game manufacturer. Such public web sites may provide a plurality of open forums directed to different topics, and some of these forums may be directed to discussions relevant to the wagering game industry. The monitoring system 806 may be configured to access particular public forums that address subjects in the wagering game industry. Alternatively, the monitoring system 806 may find such public forums by using search engines 812 on the network 808. The monitoring system 806 may input key words, such as the names of specific wagering games, gaming establishments, and/or wagering game manufacturers.

In general, the monitoring system 806 accesses message board web sites 809 and mines their content to find relevant information. For example, the monitoring system 806 searches the text on the message board web sites 809 for key words. When the monitoring system 806 identifies a message that generates interest in a wagering game, wagering game web site, gaming establishment, a wagering game manufacturer, and/or other marketable aspect of the wagering game industry, the monitoring system 806 identifies the author of the message. In particular, message board web sites typically provide a handle for each posted message. As FIG. 9 illustrates, forum page 900 provides a section 904 that identifies a handle 904a (“John Player”) associated with the message post 912. The monitoring system 806 then matches the handle with a player listed in the player account system 804. In some cases, to ensure that he/she receives rewards for his/her network-based communications, the player may provide the handle 912a and the name of the corresponding public forum to the player account system 804 to help the monitoring system 806 find the player's posted messages.

As described above, the interest generated by the messages posted on message board web sites 809 are evaluated to determine what reward to give to players. The number of direct responses to a posted message measures the level of interest. In addition, the level of potential interest may be measured by considering the number of messages posted by the same author. For example, the section 904 associated with the message post 912 in FIG. 9 provides a counter 904b that indicates the number of messages posted under the same handle 904a. A poster who posts more messages may gain more attention and popularity on a message board web site, and as a result, his/her posted messages are likely to draw more interest.

Some message board web sites 809 (such as REDDIT®) allow readers to respond to a message post by indicating whether they like (e.g., “upvote” on REDDIT®) or dislike (e.g., “downvote” on REDDIT®) a message post. Such message board web sites may then promote or demote the message post according to the number of like and dislike votes from the readers. The message posts with more likes than dislikes are displayed closer to the top of the list of posted messages. Thus, it is contemplated that the number of replies to a posted message in some embodiments may be measured according to the number of like and dislike votes. Like votes generate positive interest, while dislike votes generate less positive interest. The reward that the player receives, in some cases, may be decreased by measurements of negative interest. In these embodiments, a posted message may also be evaluated according to the position of the posted message in the list of ranked posted messages.

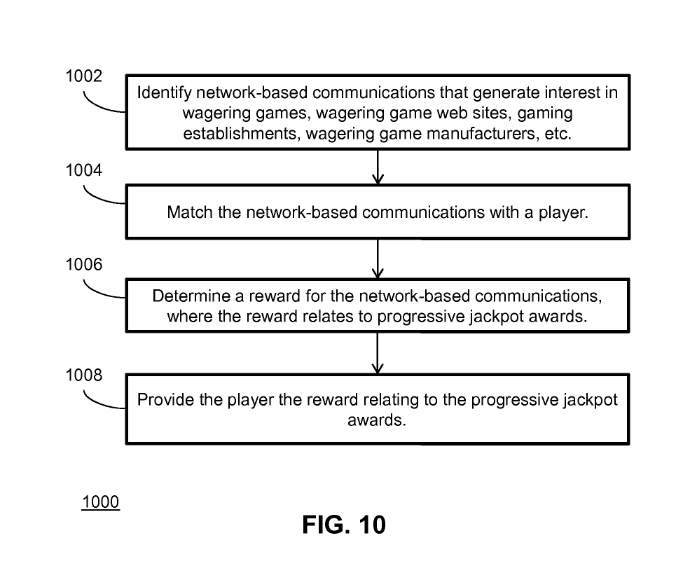

Accordingly, FIG. 10 illustrates an example approach 1000 for granting rewards relating to progressive jackpot awards based on a player's network-based communications. In act 1002, network-based communications are monitored by the monitoring system 806 to identify any electronically published information relating to a wagering game, a wagering game web site, a wagering game manufacturer, a gaming establishment, and/or any other marketable aspect of the wagering game industry. In addition to message board web sites 809, such communications may occur, for example, on weblog (“blog”) sites 810a, microblog sites 810b (such as TWITTER® or TUMBLR®), social networking sites 810c (such as FACEBOOK®), location-based social networking sites 810d (such as FOURSQUARE®), multimedia/content posting sites 810e (such as YOUTUBE® or PINTERIST®), and other media/communications sites 810f where information can be electronically shared. Accordingly, the monitoring system 806 searches the sites 809, 810a-f to find communications that generate interest in certain aspects relating to the wagering game industry.

The monitoring system 806 may perform the searches at particular times and/or periodically (e.g., every minute, hourly, daily, etc.). In some embodiments, the monitoring system 806 may search for communications that were posted between a start date/time (e.g., Mar. 1, 2012, 12:00 AM) and an end date/time (e.g., Mar. 31, 2012, 11:59 PM). As shown in FIG. 9, for example, the message post 912 includes a timestamp 912b for the posting of the message post 912 (i.e., the message post 912 was posted Mar. 15, 2012, 12:00 pm).

In some embodiments, the monitoring system 806 may employ a search engine to find, on the network 808, appearances of key words in communications discussing certain subjects related to the wagering game industry. The search engine, for example, may crawl the World Wide Web and locate the key words in any site on the World Wide Web. Indeed, FIG. 8 shows that the monitoring system 806 can access third party search engines 812 (such as GOOGLE®) to find the appearance of relevant key words.

Alternatively, the monitoring system 806 may search a narrower list of predetermined sites. In these alternative embodiments, players may be required to communicate on selected sites to particular audiences, such as social media sites/pages that are of particular interest to players of wagering games. Examples include the forum page 900 hosted by a wagering game manufacturer or a public FACEBOOK® page for a group that likes a specific wagering game.

Once act 1002 identifies the communication that generates interest in a subject relating to the wagering game industry, act 1004 identifies the player whom should be rewarded. The author of the communication is typically identified on, or otherwise associated with, the web page on which the communication appears. As shown in FIG. 8, the monitoring system 806 is coupled to a player account system 804, which includes a list of players who have enrolled to earn rewards relating to progressive games on the gaming system 802 based their network-based communications. The monitoring system 806 matches the author identified on the site with a player listed in the account system 804. In some embodiments, during enrollment, a player may indicate the web sites he/she uses and the author names (e.g., pseudonyms or pen names) he/she uses on these web sites. During this enrollment process, the monitoring system 806 may verify that it can match the player with the author names indicated on the designated sites. The monitoring system 806 can then directly monitor the sites for activity associated with the author names. In some embodiments, if the monitoring system 806 cannot match the communication identified in act 1002 with a player in the player account system 804, the monitoring system 806 may attempt to contact the author of the communication to establish a match or to invite the player to enroll in the player account system 804 to earn rewards for his/her network-based communications.

After the player is identified in act 1004 as the author of the communication, act 1006 determines the appropriate reward for the communication. In some embodiments, for example, the player becomes immediately eligible to play a progressive game to win a progressive jackpot award. In other embodiments, the player is rewarded with an incremental number of reward points that are tracked with his/her account in the player account system 804, and the player earns an opportunity to play the progressive game when the number of reward points exceeds a threshold number. In further embodiments, the player is allowed to buy a direct opportunity to play the progressive game. In some embodiments, each communication receives the same reward, regardless of the level of interest it generates. In other embodiments, the reward may be enhanced according to a measurable level of interest it generates.

The monitoring system 806 may determine the level of interest by evaluating the responses to the communication and other information on the web page. This measurement may take place at the specified date/time or a specified period after the communication has been identified. The player then receives the reward in act 1008 in the form of an electronic token, redeemable coupon, etc.

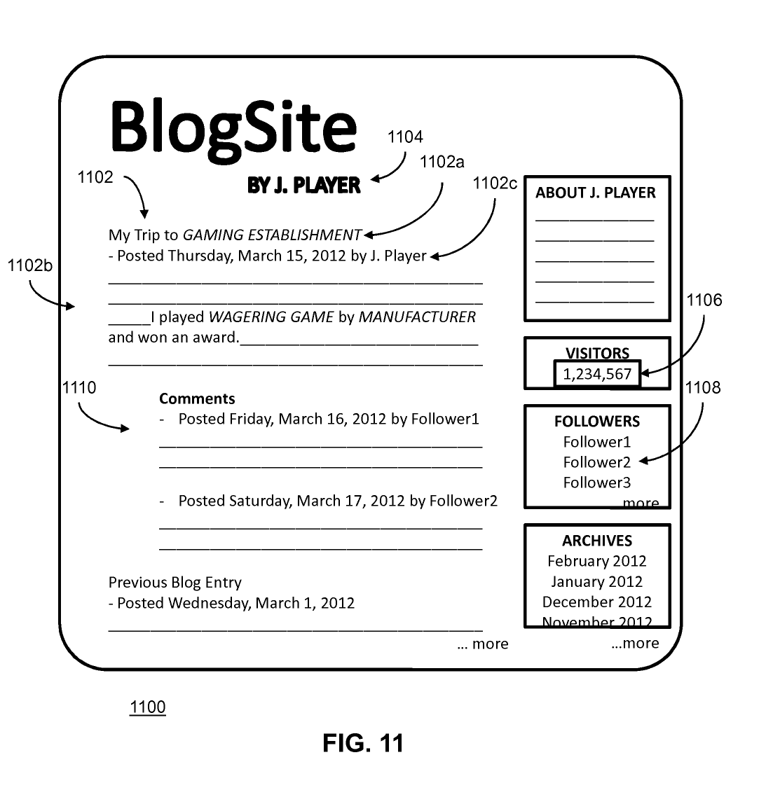

Additional relevant aspects of network-based communications are described in greater detail with reference to the examples of FIGS. 11-15. FIG. 11 illustrates an example weblog page 1100 on a weblog site 810a. In particular, the page 1100 includes weblogs from a player (“J. Player”) who is enrolled to receive rewards relating to progressive jackpot awards. As shown in FIG. 11, the player has posted a weblog 1102. The title 1102a of the weblog 1102 includes the name of a gaming establishment (“GAMING ESTABLISHMENT”). The body 1102b of the weblog 1102 includes the name of a wagering game (“WAGERING GAME”) and the name of the manufacturer of the wagering game (“MANUFACTURER”). As such, the weblog 1102 can generate interest in the gaming establishment, the wagering game, and the wagering game manufacturer. The player receives a reward for publicizing these subjects relating to the wagering game industry.

The monitoring system 806 accesses the weblog page 1100 and mines the content of the weblog page 1100 to find relevant information. For example, the monitoring system 806 searches the text on the weblog page 900 for key words. In particular, the monitoring system 806 identifies the content in weblog 1102 in connection with the author of the weblog 1102. As shown in FIG. 11, the weblog page 1100 includes a byline 1104 that indicates the author for the page 1100. In addition, the posting information 1102c for the weblog 1102 also indicates the author for the weblog 1102. The monitoring system can extract the name of the author from the byline 1104 or the posting information 1102c. The monitoring system 806 then matches the author's name with a player listed in the player account system 804.

The monitoring system 806 also evaluates the content of the weblog page 1100 to determine the reward the player should receive for the interest generated by the weblog 1102. The interest generated by the weblog 1102 is potentially greater if the weblog 1102 reaches a larger audience. For example, if the weblog site is very popular, more people will likely read about the gaming establishment, the wagering game, and the wagering game manufacturer mentioned in the weblog 1102. The popularity of a weblog site can be quantitatively measured by the number of times the weblog site has been visited and/or the number of people who follow the weblog page 1100. Such statistics are often shown on weblog pages. As shown in FIG. 11, the weblog page 1100 includes a counter 1106 for the number of total visits to the page 1100. In addition, the weblog page 1100 includes a list 1108 of active followers of the page 1100.

As FIG. 11 also shows, the weblog page 1100 includes comments 1110 posted by other individuals in direct response to the weblog 1102. Although the number of visits and the number of followers provide a general indication of the popularity of the page, they do not indicate the interest the particular weblog 1102 has directly generated. The number of comments 1110 establishes that people have actually read the weblog 1102 and have shown enough interest to comment on the weblog 1102.

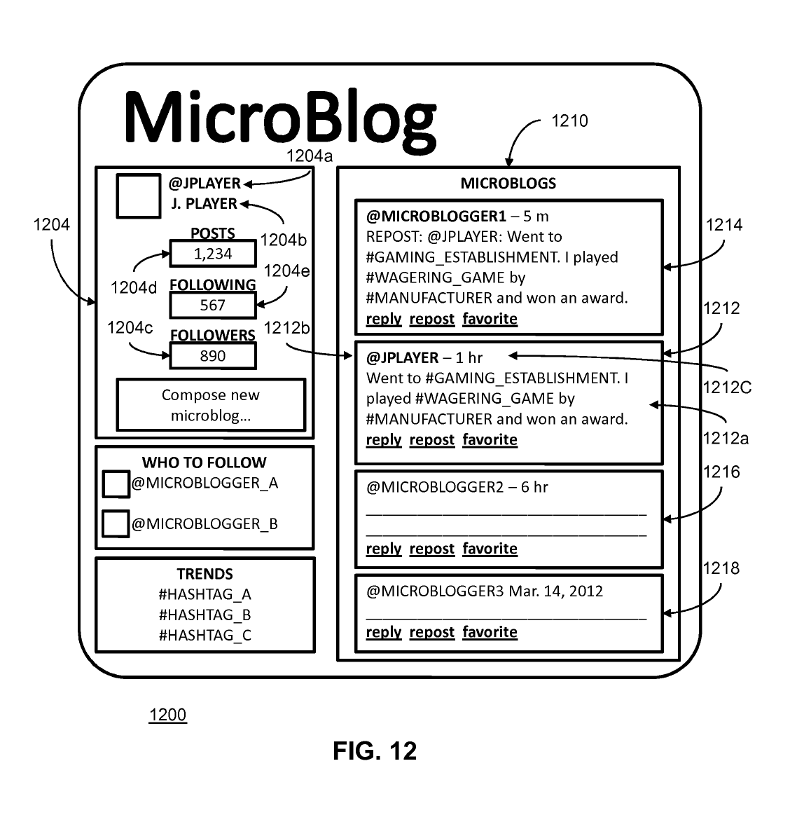

FIG. 12 illustrates an example microblog page 1200 on a microblog site 810b. In particular, the microblog page 1200 includes a series of microblogs 1210, e.g., TWEETS® on a TWITTER® page. The series of microblogs 1210 includes a microblog 1212 posted under a handle “@JPLAYER” associated with a player who is enrolled to receive rewards relating to progressive jackpot awards. The series of microblogs 1210 also includes microblogs 1014, 1016, 1018 from microbloggers that the player has chosen to follow, @MICROBLOGGER1, @MICROBLOGGER2, @MICROBLOGGER3, respectively.

The body 1212a of the microblog 1212 posted by the player mentions the name of a gaming establishment (“GAMING ESTABLISHMENT”), the name of a wagering game (“WAGERING GAME”), and the name of the manufacturer of the wagering game (“MANUFACTURER”). As shown in FIG. 12, the player mentions the names of the gaming establishment, the wagering game, and the manufacturer as hashtags (“#GAMING_ESTABLISHMENT,” “#WAGERING_GAME,” “#MANUFACTURER”), which highlight their use as key words and links the microblog 1212 to other microblogs that make the same mentions. Alternatively or additionally, the player may mention the handles (e.g., “@GAMING_ESTABLISHMENT,” “@WAGERING_GAME,” “@MANUFACTURER”) for accounts on the microblog site that have been set up to market the gaming establishment, the wagering game, and/or the wagering game manufacturer, etc. In general, the microblog 1212 generates interest in the gaming establishment, the wagering game, and the wagering game manufacturer. Again, the player receives a reward for publicizing the names of the gaming establishment, the wagering game, and/or the wagering game.

To find the player's communication, the monitoring system 806 accesses the microblog page 1200 and mines the content of the microblog page 1200 to find relevant information. For example, the monitoring system 806 searches the text on the microblog page 1200 for key words. In particular, the monitoring system 806 identifies the content in microblog page 1200 in connection with the handle associated with the microblog page 1200. As shown in FIG. 12, the microblog page 1200 includes a section 1204 that provides information about the microblog page 1200. The section 1204 indicates the handle 1204a (“@JPLAYER”) and username 1204b (“J. PLAYER”) associated with the microblog page 1200. The microblog 1212 also includes a heading 1212b that provides the handle associated therewith. The monitoring system 806 then matches the handle/username with a player listed in the player account system 804.

The monitoring system 806 evaluates the content of the microblog page 1200 to determine the reward the player should receive for the interest generated by the microblog 1212. The interest generated by the microblog 1212 is potentially greater if the microblog 1212 reaches a larger audience. For example, if the player is widely followed on the microblog page 1200, more people will likely read about the gaming establishment, the wagering game, and the wagering game manufacturer mentioned in the microblog 1212. The popularity of the microblog page 1200 can be quantitatively measured by the number of people who follow the player on the microblog page 1200. The information section 1204 includes a counter 1204c for the number of followers, as well as a counter 1204d for the number of microblogs posted under the player's handle/username 1204a/1204b and a counter 1204e for the number of other microbloggers followed by the player. The number of microblogs posted under the player's handle/username 1204a/1204b may also be an indicator of the popularity of the microblog page 1200, as the microblog page 1200 is likely to draw more interest if there is greater activity from the player. The number of other microbloggers being followed may also be an indicator of the popularity of the microblog page 1200, as the pages that follow other microbloggers are more likely to gain their own followers.

As FIG. 12 also shows, the microblogs 1212 can be reposted by, draw replies from, or be favorited by other microbloggers. For example, the microblog 1214 has reposted the content of microblog 1212. The numbers of reposts, replies, and favorites establish that people have actually read the microblog 1212 and have shown enough interest to act in response to the microblog 1212. The reposts/replies/favorites in response to the microblog 1212 appear on the microblog pages of the other microbloggers and their followers. As such, the content of the microblog, including mentions of the gaming establishment, the wagering game, and the manufacturer, may become viral, i.e., spread expontentially. When mentions of particular hashtags and other key words appear frequently enough, the hashtags and key words may highlighted by the microblog site as trending topics. The interest generated by the microblog 1212 is particularly high if its content becomes viral or starts to trend. The monitoring system 806 may identify the reposts/replies/favorites on the microblog page 1200 of the player and/or may search the pages of other microbloggers on the microblog site.

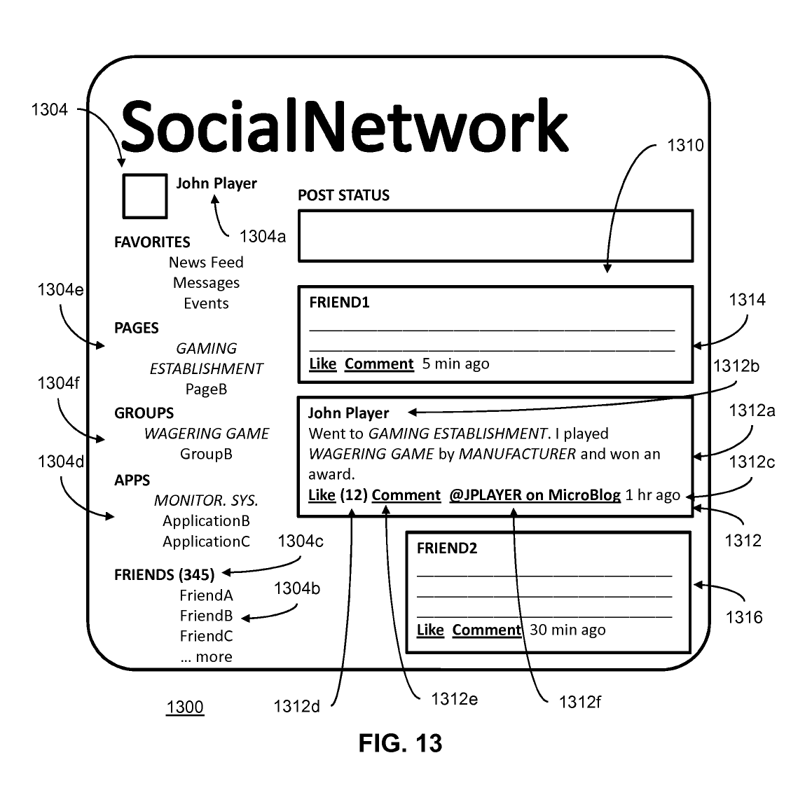

FIG. 13 illustrates an example social networking page 1300 for a social networking site 810c. The social networking page 1300 is established under a username 1304a (“John Player”), which is associated with a player who is enrolled in the player account system 804 to receive rewards relating to progressive jackpot awards. The social networking page 1300 includes a series of status posts 1310 posted by people connected to a social network defined by the player under the username 1304a. The series of status posts 1310 includes a status post 1312 posted under the username 1304a. The status posts 1310 also include a status post 1314 under username “FRIEND1.”

The body 1312b of the status post 1312 mentions the name of a gaming establishment (“GAMING ESTABLISHMENT”), the name of a wagering game (“WAGERING GAME”), and the name of the manufacturer of the wagering game (“MANUFACTURER”). As such, the status post 1312 generates interest in the gaming establishment, the wagering game, and the wagering game manufacturer. The player receives a reward for publicizing the names of the gaming establishment, the wagering game, and/or the wagering game on the social networking page 1300.

As shown in FIG. 13, an information section 1304 that provides information for the social networking page 1300, including the list 1304b of friends (members) associated with the social network. The social networking site may generally restrict access to the social networking page 1300 to the list 1304b of friends. As such, the player may have to grant the monitoring system 806 access to the social networking page 1300. In some cases, the monitoring system 806 may access the page under a username that is accepted as a friend under the list 1304b. In some other cases, the player may grant permission to a special application which in turn allows the monitoring system 806 to collect data from the social networking page 1300. As FIG. 13 illustrates, the information section 1304 also includes a list 1304d of applications (e.g., social network games, utilities, etc.) that the player has added to the social networking page 1300, including an application (“MONITOR.SYS.”) which gives the monitoring system 806 the access to the player's social networking page 1300.

The necessary information for accessing the social networking page 1300 may be stored with the player information in the player account system 804. Accordingly, the monitoring system 806 can directly access the social networking page 1300 and mine the content of the social networking page 1300 to find the player's communication. For example, the monitoring system 806 searches the text on the social networking page 1300 for key words. In particular, the monitoring system 806 identifies the status post 1312 which contains key words, e.g., “GAMING ESTABLISHMENT,” “WAGERING GAME,” and “MANUFACTURER,” in the body 1312a. The status post 1312 includes author information 1312b, which the monitoring system 806 can use to confirm that the status post 1312 was posted by the player under the username 1304a (“John Player”).

The monitoring system 806 also evaluates the content of the social networking page 100 to determine the reward the player should receive for the interest generated by the status post 1312. The interest generated by the status post 1312 is potentially greater if the status post 1312 reaches a larger audience. For example, if the player is widely followed on the social networking page 1300, more people will likely read about the gaming establishment, the wagering game, and the wagering game manufacturer mentioned in the posted status post 1312. The popularity of the social networking page 1300 can be quantitatively measured by the number of friends in the player's social network who can potentially see the status post 1312. The information section 1304 includes a counter 1304c for the number of friends in the player's social network. Thus, the monitoring system 806 can read the counter 1304c and factor the number of friends in the player's social network into its determination of the interest generated by the status post 1312.

As FIG. 13 also shows, friends in the player's social network can respond to the status post 1312. For example, the friends can demonstrate their approval of the status post 1312 by using a “Like” function 1312d associated with the status post 1312. The “Like” function 1312d includes a counter for the number of approvals. In addition, friends can reply directly to the status post 1312 by employing the “Comment” function 1312e associated with the status post 1312. As shown in FIG. 13, a reply has been posted under username “FRIEND2.” The number of approvals and the number of replies establish how many friends have actually read the status post 1312 and have shown enough interest to respond. Advantageously, the approvals and replies associated with the status post 1312 appear on the social networking pages of the responding friends. As such, the content of the status post, including mentions of the gaming establishment, the wagering game, and the manufacturer, may spread widely or become viral, thereby generating significant interest.

As shown in FIG. 13, the player's status posts on the social networking page 1300 may be published on another social media site, which is linked by an application to the social networking page 1300. For example, the status post 1312 also includes a reference 1312f, which indicates that the content of the body 1312a is also posted under the handle “@JPLAYER” on the social media site “MicroBlog” as shown in FIG. 12. Thus, the publicity of the information in the status post 1312 increases with the player's social media activity extending across multiple sites. As such, the monitoring system 806 may determine a greater reward for the status post 1312 based on the link to another social media site. Additionally or alternatively, the monitoring system 806 may directly access the player's microblog page as described above to evaluate the additional interest resulting from the player's activity on that page.

FIG. 13 also illustrates a list 1304e that links the social networking page 1300 to public pages that allow organizations or businesses to reach out to, and interact with, an audience or customers. The public pages may be similar to the weblog page 1100 in that people may post comments and interact in response to content provided on the public page. The list 1304e includes pages that are of interest to the player. Such public pages may be established by gaming establishments, wagering game manufacturers, etc. For example, the list 1304e includes a link to a page for “GAMING ESTABLISHMENT.”

In addition, FIG. 13 illustrates a list 1304f that links the social networking page 1300 to group pages. Group pages may be similar to the social networking page 1300. However, unlike the social networking page 1300 which organizes members according to their relationship to the player, the members of a group page are organized according to a common interest. The list 1304f includes groups in which the player is a member. Such groups may be established to organize members around a common interest in gaming establishments, wagering game manufacturers, etc. For example, the list 1304f includes a link to group with a particular interest in “WAGERING GAME.”

The player's activity on public pages and group pages provide another way to publicize subjects relating to the wagering game industry. To encourage such publicity, the monitoring system 806 may also reward the player for including links to certain public pages and/or group pages. Additionally or alternatively, the monitoring system 806 may directly access the public pages or group pages to evaluate the additional interest resulting from the player's activity on those other pages.

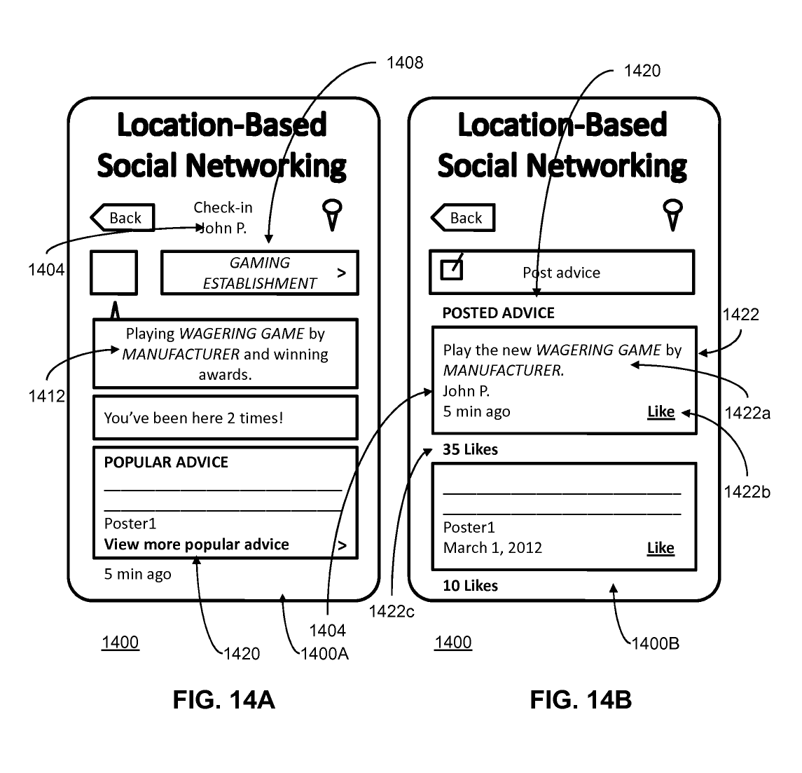

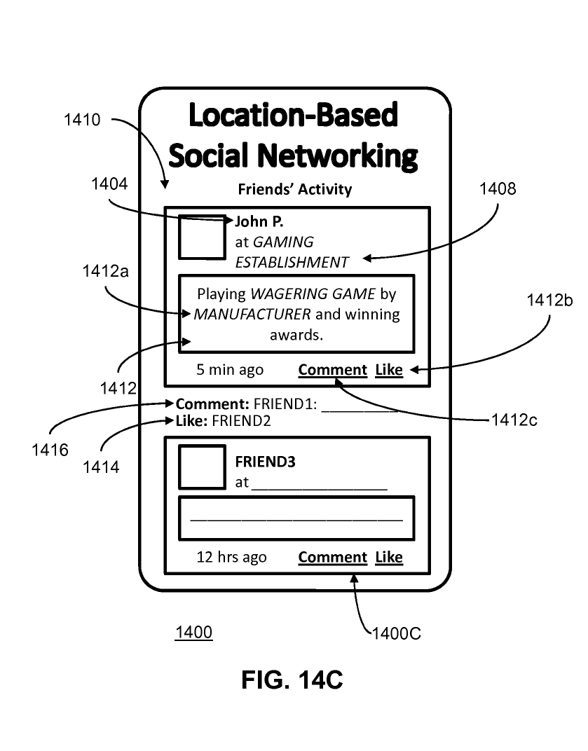

FIGS. 14A-C illustrates example location-based social networking screens 1400A-C of a mobile application 1400 for a location-based social networking site 810d. The social networking screens 1400A-C are associated with an account for username 1404 (“John P.”), which is associated with a player who is enrolled in the player account system 804 to receive rewards relating to progressive jackpot awards. The mobile application 1400 described with reference to FIGS. 14A-C provides a special interface that displays the touch screens 1400A-C on a portable computing device, such as a smart phone or tablet, that communicates over a wireless telecommunications network. As such, the mobile application 1400 demonstrates that the players may receive rewards for communications through different types of applications, interfaces, networks, and devices.

The mobile application 1400 allows the player to interact over social media by providing information on his/her location which is tracked by GPS (or similar) functionality on the portable computing device. The screen 1400A of FIG. 14A displays a point-of-interest (or location) 1408. In particular, the displayed point-of-interest 1408 indicates that the player is located at or near a particular gaming establishment (“GAMING ESTABLISHMENT”). In some embodiments, the mobile application 1400 determines the player's location by GPS and provides a list of known points-of-interest near that location. The player selects the point-of-interest 1408 from the list, which is then displayed on the screen 1400A. In other words, the player “checks in” with the location-based social networking site by posting his/her location.

In addition, the player and others who have checked into the same point-of-interest can provide advice or other information about the point-of-interest. As shown in FIGS. 14A-B, the screens 1400A-B include advice posts 1420 relating to the point-of-interest post 1408. The advice posts 1420 are visible to anyone who accesses the location-based social networking site. The listing of advice posts 1420 on screen 1400B includes an advice post 1422 posted by the player on screen 1400B. The body 1422a of the advice post 1422 mentions a wagering game (“WAGERING GAME”) and a wagering game manufacturer (“MANUFACTURER”). When people read about the gaming establishment on the location-based social networking site, they see the corresponding advice posts 1420. Specifically, the player's advice post 1422 draws interest to the wagering game and the wagering game manufacturer. Advantageously, people who are also checking into the same point-of-interest on the location-based social networking site are at the gaming establishment where they can act on the advice by playing the specific wagering game or other games from the particular manufacturer.

The location-based social networking site publishes that the player is at the point-of-interest 1408 and indicates how many other people have checked in at the same point-of-interest 1408. In addition, the location-based social networking site publishes the advice posts 1420 associated with the point-of-interest 1408. Accordingly, the player's communication on the location-based social networking site generates interest in the gaming establishment, the wagering game, and the wagering game manufacturer.

Furthermore, the screen 1400A allows the player to provide details on what he/she is doing at the location 1408. As shown in FIG. 14A, the player posts an activity post 1412. The body 1412a of the activity post 1412 mentions the name of the wagering game (“WAGERING GAME”) and the name of the manufacturer of the wagering game (“MANUFACTURER”). Similar to the posted statuses on the social networking page 1300, the activity post 1412 is published specifically to friends (members) of the player's social network on the location-based social networking site. FIG. 14C illustrates a screen 1400c as seen by a member of the player's social network. In a list of activity posts 1410, the screen 1400c shows the player's activity post 1412 as well as the player's location 1408. In particular, by posting the activity post 1412, the player generates further interest in the wagering game and the wagering game manufacturer.

The player receives a reward based on the interest he/she generates for the gaming establishment, the wagering game, and/or the wagering game on the location-based social networking site. The monitoring system 806 evaluates the content of the location-based social networking site to determine the reward the player should receive for checking in with the point-of-interest 1408 and posting the advice post 1422 and the activity post 1412. The interest generated by these actions is potentially greater if information reaches a larger audience. For example, if the player is widely followed on the location-based social networking site, more people will likely read about the gaming establishment, the wagering game, and the wagering game manufacturer mentioned in his/her check-in as well as the advice post 1422 and the activity post 1412. Some of the generated interest can be quantitatively measured by the number of friends in the player's social network who can potentially receive the player's communications.

As FIG. 14B also shows, people can respond to the advice posts 1420. In particular, people can demonstrate their approval of the advice post 1422 by using a “Like” function 1422b associated with the advice post 1422. The “Like” function 1422b includes a counter 1422c for the number of approvals. The number of approvals establishes how many friends have actually read the advice post 1422 and have shown enough interest to respond. The number of approvals may also draw more interest to the advice post 1422. As such, the number of approvals may be used to determine the reward for the player.

As FIG. 14C also shows, people can respond to the activity posts 1410. In particular, people can also demonstrate their approval of the activity post 1412 by using the “Like” function 1412b associated with the activity post 1412. The screen 1400c displays the approvals 1414 from friends (e.g., FRIEND1) who use the “Like” function 1412b. In addition, members can reply directly to the activity post 1412 by employing the “Comment” function 1412c associated with the activity post 1412. As shown in FIG. 14C, screen 1400c displays the corresponding comments 1416 from friends (e.g., FRIEND2). The number of approvals and the number of comments establish how many members have actually read the status post 1412 and have shown enough interest to respond. As such, the number of approvals and the number of comments may be used to determine the reward for the player. Advantageously, the approvals and comments associated with the activity post 1412 are also seen by other friends in the player's social network. As such, the content of the activity post 1412, including mentions of the gaming establishment, the wagering game, and the manufacturer, may spread widely or become viral.

The monitoring system 806 accesses the location-based networking site and identifies communications from the player that generate interest in certain subjects relating to the wagering game industry. Each communication is associated with the player through the username 1404. Although the player's check-in and advice post 1412 may be publicly accessible, access to the player's activity posts may be restricted to the player's designated friends on the location-based social networking site. As such, the player may have to grant the monitoring system 806 permission to monitor his/her activity posts directly, e.g., with an account established for the monitoring system 806.

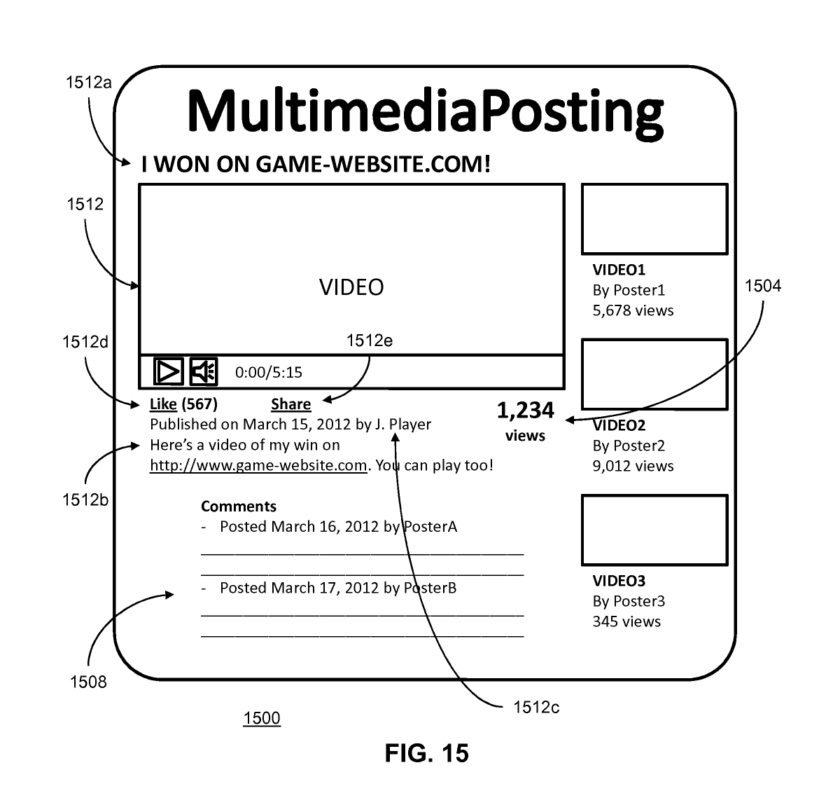

FIG. 15 illustrates an example multimedia posting page 1500 on a multimedia posting site 810e. For example, the page 1500 includes a video posting 1512 from a player (“J. Player”) who is enrolled to receive rewards relating to progressive jackpot awards. The video posting 1512 documents the player playing a wagering game on a wagering game web site, such as the web site 84 described above. The title 1512a and the caption 1512b of the video posting 1512 mention the name of the wagering game. As such, the video posting 1512 generates interest in the wagering game web site. Indeed, the caption 1512b also includes a hyperlink to the wagering game web site to encourage people to visit. The player receives a reward for the video posting 1512.

The monitoring system 806 accesses the multimedia posting page 1500 and mines the content of the multimedia posting page 1500 to find relevant information, e.g., searches the text for key words. In particular, the monitoring system 806 identifies the content associated with the video posting 1512 in connection with the author of the video posting 1512. As shown in FIG. 15, the video posting 1512 also includes posting information 1512c which indicates the author. The monitoring system 806 can extract the name of the author from the posting information 1512c. The monitoring system 806 then matches the author's name with a player listed in the player account system 804.

The monitoring system 806 also evaluates the content of the multimedia posting web page 1500 to determine the reward the player should receive for the video posting 1512. The interest generated by the video posting 1512 is potentially greater if the video posting 1512 reaches a larger audience. The popularity of a video posting 1512 can be quantitatively measured by the number of times the video posting 1512 has been viewed. As shown in FIG. 12, the multimedia posting page 1500 includes a counter 1504 for the number of views of the video posting 1512.

As FIG. 15 also shows, people can respond to the video posting 1512. In particular, people can demonstrate their approval of the video posting 1512 by using a “Like” function 1512d associated with the video post 1512. The “Like” function includes a counter to indicate the number of the approvals from viewers. In addition, viewers can post comments 1508 on the video posting 1512. The number of approvals and the number of comments establish how many members have shown enough interest to respond to the video posting 1512. As such, the number of approvals and the number of comments may be used to determine the reward for the player.

In addition, the multimedia posting page 1500 also provides a “Share” function that allows viewers to share the video posting 1512 on other social media web sites, thereby allowing the video posting 1512 spread widely or become viral and generate interest in the wagering game web site.

As described above, the monitoring system 806 may be configured to access specific web sites to find communications by players. In one embodiment, the monitoring system 806 may consider a single forum hosted by a wagering game manufacturer for registered members. In other embodiments, the monitoring system 806 may access certain public social media web sites.

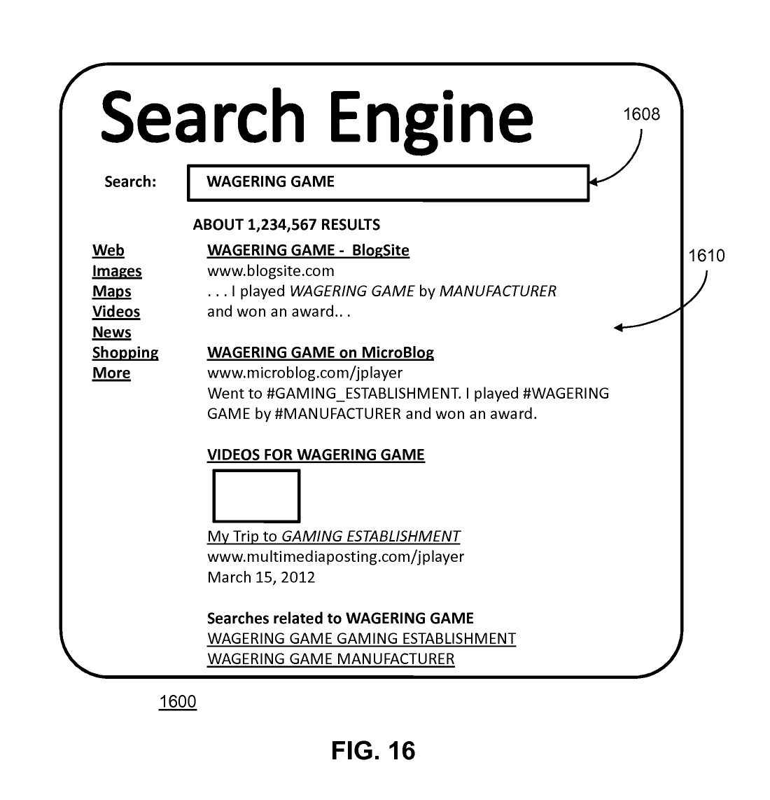

However, as also described above, the monitoring system 806 may employ a search engine to find communications by people on any web site throughout a network. The search engine, for example, may crawl the World Wide Web and locate the relevant key words, e.g., the name of a wagering game, in any site accessible on the network. FIG. 16 illustrates an example search engine web page 1600 on a search engine site 812. In this example, the search engine web page 1600 displays a listing 1610 of search results for a key word entry 1608 providing the name of a particular wagering game (“WAGERING GAME”). The search results may include communications from players that generate interest in the particular wagering game. The monitoring system 806 can mine these results to identify players who should receive a reward. The search results may be narrowed by considering results that relate to certain social media web sites. Indeed, the specific names of social media web sites may also be used for the key word entry 1608. It is also understood that social media web sites provide their own search functions; the monitoring system 806 may additionally or alternatively employ these search functions.

Search engines typically employ search engine optimization so that the web pages in in the search results listing 1610 are ranked according to the number of hits (web activity). For example, the highest ranking web page with the most hits appears at the top of the listing 1610. In addition to the different metrics described above, the level of interest generated by players' communications can also be evaluated according to their search ranking. For example, a player who posts a video that becomes viral and receives a lot of hits may receive a greater reward than a player who posts a weblog that is read by a limited number of people. As such, players are also encouraged to share information in a manner that attracts attention.

The examples described herein illustrate that players can use any of type network-based communications to share information that generates interest in a wagering game, a wagering game web site, a wagering game manufacturer, a gaming establishment, or any other marketable aspect of the wagering game industry. To encourage such communications, aspects of the present invention provide rewards to the players. In particular, the rewards relate to progressive games and progressive jackpot awards. In some cases, the rewards enhance the players' chances to play progressive games. In other cases, the rewards enhance the players' chances to win the progressive jackpot awards. According to further aspects of the present invention, the rewards may depend on the level of interest generated by the players' communications.

The examples described herein also show that data available on various social media sites can be employed to measure the level of interest generated by the players' communications. The number of followers or friends, the number of approvals (“likes” or “favorites”), the number of disapprovals (“dislikes”), the number of reposts/shares, the number of direct comments/replies, search engine ranking, etc., can be evaluated as metrics to determine a reward for a player. In many cases, data for these metrics may need to be collected after some time has elapsed after the player's communication to allow the communication to generate the interest. For example, the players may be required to communicate over social media between a start date/time and an end date/time, and a final data collection may occur at the end date/time to measure the generated interest. Alternatively, the final data collection may occur after a specific time period has elapsed from the time that the information was posted or from the time the posting was discovered, e.g., by the monitoring system 806.

For example, as described above, a player may incrementally earn a number of points to meet a threshold value and gain eligibility to play a progressive game. In this example, the number of points in the reward may be determined from any combination of metrics collected by the monitoring system 806. In some cases, each metric may receive a number of points. For a particular posting on a web site, the player may receive n1 points for each direct comment/reply, n2 points for each repost/share, n3 points for each approval, negative n4 points for each disapproval, n5 points for each follower, n6 points for search engine ranking, and so on. The number of points for each metric may be weighted according to how well they measure the generated level of interest. For example, the number of followers may be less significant than the number of approvals. The player then receives a reward equal to the sum of the points.

Although the examples herein may describe generating interest in wagering games, wagering game web sites, wagering game manufacturers, and gaming establishments, it is understood that the player may receive awards for publicizing any marketable aspects of the wagering game industry.

Although the examples herein may describe wagering games on web sites or gaming terminals, it is understood that that wagering games may be played on other devices, including, but not limited to, as mobile applications or software on smart phones, tablets, game consoles, personal computers, etc.

Although progressive jackpot awards may be funded by wagers received for other wagering games, progressive jackpot awards according to aspects of the present invention may be funded by other sources. In some embodiments, the wagering games may involve wagers of non-cash values, such as virtual currency. As such, the progressive jackpot awards of cash value must receive funding from another source. For example, progressive jackpot awards on a wagering game web site established by a wagering game manufacturer may be funded by the marketing department of the manufacturer. Furthermore, the progressive jackpot awards may have cash value, while the rewards provided for players' network-based communications do not have cash value. Thus, aspects of the present invention may provide non-cash rewards that may result in cash awards, i.e., a progressive jackpot award with cash value. In some embodiments, certain progressive jackpot awards are only awarded to those who earn eligibility as a reward for their network-based communications.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects, regardless of the embodiments referenced in the description of the elements and aspects.

What is claimed is:

1. A gaming system comprising:
one or more processing devices configured to provide displayable content over a network to a client, the displayable content providing a wagering game system, the wagering game system including a progressive wagering game that awards one or more progressive jackpot awards to a player,
wherein in response to social communications by the player over the network, the wagering game system provides a reward to the player, the reward relating to the progressive wagering game or the one or more progressive jackpot awards.

2. The gaming system of claim 1, wherein the reward affects a probability of winning the one or more progressive jackpot awards.

3. The gaming system of claim 1, wherein the reward modifies a value of the one or more progressive jackpot awards.

4. The gaming system of claim 1, wherein the reward determines an eligibility of the player to play the progressive wagering game.

5. The gaming system of claim 1, wherein the reward modifies an aspect of the progressive wagering game for play by the player.

6. The gaming system of claim 1, wherein the reward varies based on a response by other people to the social communications.

7. The gaming system of claim 1, wherein the wagering game system provides a link to a social communications site on the network, the link allowing the player to share social communications over the network.

8. The gaming system of claim 8, wherein the link to the social communications site on the network provides a prepared message for the social communications by the player, the prepared message including another link from the site on the network back to the wagering game system.

9. The gaming system of claim 1, wherein the wagering game system provides the reward for each social communication by the player over the network, and the player becomes eligible to win the one or more progressive jackpot awards after receiving a plurality of the rewards.

10. The gaming system of claim 1, wherein the wagering game system includes one or more basic wagering games; an eligibility of the player to play the progressive wagering game is determined by an occurrence of an outcome in the one or more basic wagering games played by the player; and the reward increases the probability of the occurrence of the outcome in the one or more basic wagering game.

11. The gaming system of claim 1, wherein the wagering game system includes one or more basic wagering games; the eligibility of the player to play the progressive wagering game is determined by an occurrence of an outcome in the one or more basic wagering games played by the player; and the reward provides an amount of time for the player to achieve the occurrence of the outcome in the one or more basic wagering games.

12. The gaming system of claim 1, wherein the one or more progressive jackpot awards include a plurality of levels of progressive jackpot awards of different values, and the reward determines the level of progressive jackpot award that the player can win in the progressive wagering game.

13. A method comprising:
sending, by one or more processing devices, displayable content over a network to a client, the displayable content providing a wagering game system, the wagering game system including a progressive wagering game that awards one or more progressive jackpot awards to a player; and
in response to social communications by the player over the network, providing a reward to the player, the reward relating to the progressive wagering game or the one or more progressive jackpot awards.

14. The method of claim 13, wherein the reward affects a probability of winning the one or more progressive jackpot awards.

15. The method of claim 13, wherein the reward modifies a value of the one or more progressive jackpot awards.

16. The method of claim 13, wherein the reward determines an eligibility of the player to play the progressive wagering game.

17. The method of claim 13, wherein the reward modifies an aspect of the progressive wagering game for play by the player.

18. The method of claim 13, wherein the reward varies based on a response by other people to the social communications.

19. The method of claim 13, wherein the wagering game system provides a link to a social communications site on the network, the link allowing the player to share social communications over the network.

20. The method of claim 19, wherein the link to the social communications site on the network provides a prepared message for the social communications by the player, the prepared message including another link from the site on the network back to the wagering game system.

21. The method of claim 13, wherein providing the reward includes providing the reward for each social communication by the player over the network, and the player becomes eligible to win the one or more progressive jackpot awards after receiving a plurality of the rewards.

22. The method of claim 13, wherein the wagering game system includes one or more basic wagering games; an eligibility of the player to play the progressive wagering game is determined by an occurrence of an outcome in the one or more basic wagering games played by the player; and the reward increases the probability of the occurrence of the outcome in the one or more basic wagering game.

23. The method of claim 13, wherein the wagering game system includes one or more basic wagering games; the eligibility of the player to play the progressive wagering game is determined by an occurrence of an outcome in the one or more basic wagering games played by the player; and the reward provides an amount of time for the player to achieve the occurrence of the outcome in the one or more basic wagering games.

24. The method of claim 13, wherein the one or more progressive jackpot awards include a plurality of levels of progressive jackpot awards of different values, and the reward determines the level of progressive jackpot award that the player can win in the progressive wagering game.

25. A gaming system comprising:
a display device configured to display a progressive wagering game that awards one or more progressive jackpot awards to a player; and
one or more processing devices configured to identify social communications by the player over a network and provide a reward to the player in response to the communications by the player over the network, the reward relating to the progressive wagering game or the one or more progressive jackpot awards.

26. One or more physical machine-readable storage media including instructions which, when executed by one or more processors, cause the one or more processors to perform operations comprising:
providing a progressive jackpot award at a gaming website on a network; and
in response to social communications over the network by a player of games at the gaming website, modifying at least one of a probability of the player winning the progressive jackpot award and an amount of the progressive jackpot award if won by the player.

27. The physical machine-readable storage media of claim 26, wherein the operations further include providing the player with chances of winning the progressive jackpot award as the player plays the games at the gaming website, wherein the modifying includes providing the player with an additional chance of winning the progressive jackpot award.

28. The physical machine-readable storage media of claim 26, wherein the operations further include, in response to the social communications over the network by the player, contributing an amount to the progressive jackpot award.

29. The physical machine-readable storage media of claim 26, wherein the operations further include awarding the progressive jackpot award if the contributed amount causes the progressive jackpot award to reach a predetermined threshold.

30. The physical machine-readable storage media of claim 26, wherein the operations further include measuring an effect of the social communications on bringing other players to the gaming website, and wherein the modifying varies with the measured effect.
